(19) United States
(12) Patent Application Publication
(10) Pub. No.: US 2015/0284637 A1
(43) Pub. Date: Oct. 8, 2015

(54) LIQUID CRYSTAL COMPOSITION AND LIQUID CRYSTAL DISPLAY DEVICE

(71) Applicants: JNC CORPORATION, Tokyo (JP); JNC PETROCHEMICAL CORPORATION, Tokyo (JP)

(72) Inventors: YOSHIMASA FURUSATO, CHIBA (JP); MASAYUKI SAITO, CHIBA (JP)

(21) Appl. No.: 14/620,167

(22) Filed: Feb. 11, 2015

(30) Foreign Application Priority Data
Apr. 2, 2014 (JP) 2014-076370
Oct. 1, 2014 (JP) 2014-202813

(51) Int. Cl. C09K 19/34; C09K 19/54; C09K 19/30

(52) U.S. Cl. CPC C09K 19/3402; C09K 19/3066; C09K 19/3001; C09K 19/542; C09K 2019/3425; C09K 2019/3422; C09K 2019/548

(57) ABSTRACT

A liquid crystal composition and an AM LCD device including the same are described. The liquid crystal composition has a negative dielectric anisotropy and contains a specific compound having a large negative dielectric anisotropy as a first component and a compound having a large optical anisotropy as a second component, and may further contain a specific compound having a high maximum temperature or a small viscosity as a third component, a specific compound having a large negative dielectric anisotropy as a fourth component, and/or a specific compound having a polymerizable group as an additive component.

### CROSS-REFERENCE TO RELATED APPLICATION

This application claims the priority benefits of Japanese Patent Application serial no. 2014-076370, filed on Apr. 2, 2014, and Japanese Patent Application serial no. 2014-202813, filed on Oct. 1, 2014. The entirety of each of the above-mentioned patent applications is hereby incorporated by reference herein and made a part of this specification.

### TECHNICAL FIELD

The invention relates to a liquid crystal composition, a liquid crystal display (LCD) device including the composition and so forth. In particular, the invention relates to a liquid crystal composition having a negative dielectric anisotropy, and an LCD device that includes the composition and has a mode such as an IPS mode, a VA mode, an FFS mode or an FPA mode, and also relates to an LCD device having a polymer sustained alignment (PSA) mode.

### BACKGROUND ART

For LCD devices, a classification based on the operating mode of liquid crystal molecules includes a phase change (PC) mode, a twisted nematic (TN) mode, a super twisted nematic (STN) mode, an electrically controlled birefringence (ECB) mode, an optically compensated bend (OCB) mode, an in-plane switching (IPS) mode, a vertical alignment (VA) mode, a fringe field switching (FFS) mode and a field-induced photo-reactive alignment (FPA) mode. A classification based on the driving mode of the device includes a passive matrix (PM) type and an active matrix (AM) type. The PM type is classified into static type, multiplex type and so forth, and the AM type is classified into a thin film transistor (TFT) type, a metal insulator metal (MIM) type and so forth. The TFT type is further classified into amorphous silicon type and polysilicon type. The latter is classified into a high temperature type and a low temperature type according to the production process. A classification based on the light source includes a reflective type using natural light, a transmissive type using a backlight, and a transflective type using both natural light and a backlight.

An LCd device includes a liquid crystal composition having a nematic phase. The composition has suitable characteristics. An AM device having good characteristics can be obtained by improving the characteristics of the composition. Table 1 below summarizes a relationship between the characteristics of the two aspects. The characteristics of the composition will be further described based on a commercially available AM device. The temperature range of the nematic phase relates to the temperature range in which the device can be used. A preferred maximum temperature of the nematic phase is about 70° C. or higher and a preferred minimum temperature of the nematic phase is about −10° C. or lower. The viscosity of the composition relates to the response time of the device. A short response time is preferred for displaying moving images on the device. A response time even shorter by one millisecond is desirable. Accordingly, a small viscosity of the composition

TABLE 1
Characteristics of Composition and AM Device

| | Characteristics | |
|---|---|---|
| No. | of Composition | Characteristics of AM Device |
| 1 | Wide temperature range | Wide usable temperature range |
| | of a nematic phase | |
| 2 | Small viscosity | Short response time |
| 3 | Suitable optical anisotropy | Large contrast ratio |
| 4 | Large positive or negative | Low threshold voltage and |
| | dielectric anisotropy | small electric power consumption, |
| | | Large contrast ratio |
| 5 | Large specific resistance | Large voltage holding ratio and |
| | | large contrast ratio |
| 6 | High stability to UV light | Long service life |
| | and heat | |

The optical anisotropy of the composition relates to the contrast ratio of the device. According to the mode of the device, a suitable optical anisotropy such as a large optical anisotropy or a small optical anisotropy is required. The product (Δn×d) of the optical anisotropy (Δn) of the composition and the cell gap (d) of the device is designed so as to maximize the contrast ratio. A suitable value of the product depends on the type of the operating mode. In a device of the VA mode, a suitable value is in the range of about 0.30 μm to about 0.40 μm, and in a device of the IPS or FFS mode, a suitable value is in the range of about 0.20 μm to about 0.30 μm. In the above cases, a composition having a largeΔn is preferred for a device having a small cell gap. A large value of Δ∈ of the composition contributes to a low threshold voltage, a small electric power consumption and a large contrast ratio of the device. Accordingly, a large value of Δ∈ is preferred. A large specific resistance in the composition contributes to a large voltage holding ratio and a large contrast ratio of the device. Accordingly, a composition having a large specific resistance at room temperature and also at a high temperature in an initial stage is preferred. A composition having a large specific resistance at room temperature and also at a high temperature even after the device has been used for a long period of time is preferred. The stability of the composition to UV light and heat relates to the service life of the device. In cases where the stability is high, the device has a long service life. Such characteristics are preferred for an AM device for use in a liquid crystal projector, a liquid crystal television and so forth.

A liquid crystal composition containing a polymer is used for an LCD device of the polymer sustained alignment (PSA) mode. First, a composition to which a small amount of polymerizable compound is added is injected into the device. Next, the composition is irradiated with UV light, while voltage is applied between substrates of the device, to polymerize the polymerizable compound and form a polymer network structure in the composition. In the composition, alignment of liquid crystal molecules can be controlled by the polymer, and therefore the response time of the device is shortened and image persistence is reduced. Such an effect of the polymer can be expected for a device having a mode such as the TN, ECB, OCB, IPS, VA, FFS or FPA.

A composition having a positive Δ∈ is used for an AM device of the TN mode. A composition having a negative Δ∈ is used for an AM device of the VA mode. A composition having a positive or negative Δ∈ is used for an AM device of the IPS or FFS mode. A composition having a positive or negative Δ∈ is used for an AM device of the PSA mode. Examples of the liquid crystal composition having a negative Δ∈ are disclosed in Patent literature No. 1 to 3 below.

Patent literature No. 1: WO 2013-175892 A

Patent literature No. 2: WO 2010-067662 A

Patent literature No. 3: JP 2000-038585 A

### SUMMARY OF INVENTION

The invention provides a liquid crystal composition satisfying at least one of characteristics such as a high maximum temperature of nematic phase, a low minimum temperature of nematic phase, a small viscosity, a suitable optical anisotropy, a large negative dielectric anisotropy, a large specific resistance, a high stability to UV light and a high stability to heat, or a liquid crystal composition having a suitable balance regarding at least two of the characteristics. The invention further provides an LCD device including such a composition. The invention additionally provides an AM device having characteristics such as a short response time, a large voltage holding ratio, a low threshold voltage, a large contrast ratio and a long service life.

The liquid crystal composition of the invention has a negative dielectric anisotropy and contains at least one compound selected from the group consisting of compounds represented by formula (1) as a first component and at least one compound selected from the group consisting of compounds represented by formula (2) as a second component. The LCD device of the invention includes the composition.

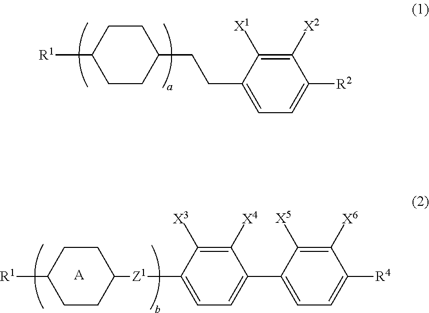

In formulae (1) and (2), R¹ is alkenyl having 2 to 4 carbons; R² is alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen; R³ and R⁴ are independently alkyl having 1 to 12 carbons, alkoxy having 1 to 12 carbons, or alkyl having 1 to 12 carbons in which at least one hydrogen is replaced by halogen; ring A is 1,4-cyclohexylene, 1,4-cyclohexenylene, 1,4-phenylene, 1,4-phenylene in which at least one hydrogen is replaced by fluorine or chlorine, or tetrahydropyran-2,5-diyl; X¹ and X² are independently fluorine or chlorine; X³, X⁴, X⁵ and X⁶ are independently hydrogen or fluorine; Z¹ is a single bond, —CH₂CH₂—, —CH₂O—, —OCH₂—, —COO— or —OCO—; a is 1 or 2; and b is 0 or 1.

The invention also concerns use of the liquid crystal composition in an LCD device.

The invention further concerns use of the liquid crystal composition in a PSA-mode LCD device.

The liquid crystal composition of the invention satisfies at least one of characteristics such as a high maximum temperature of nematic phase, a low minimum temperature of nematic phase, a small viscosity, a suitable optical anisotropy, a large negative dielectric anisotropy, a large specific resistance, a high stability to UV light and a high stability to heat, or has a suitable balance regarding at least two of the characteristics. The LCD device of the invention includes such a composition. The AM device of the invention has characteristics such as a short response time, a large voltage holding ratio, a low threshold voltage, a large contrast ratio and a long service life.

### DESCRIPTION OF EMBODIMENTS

Usage of terms herein is as described below. The term “liquid crystal composition” and “LCD device” may be occasionally abbreviated as “composition” and “device,” respectively. “LCD device” is a generic term for an LCD panel and an LCD module. “Liquid crystal compound” is a generic term for a compound having a liquid crystal phase such as a nematic phase and a smectic phase, and a compound having no liquid crystal phase but being mixed with the composition for adjusting characteristics such as the temperature range of nematic phase, viscosity and dielectric anisotropy. The compound has a six-membered ring such as 1,4-cyclohexylene and 1,4-phenylene, and has rod like molecular structure. “Polymerizable compound” includes a compound to be added to the composition for forming a polymer in the composition.

The liquid crystal composition is prepared by mixing a plurality of liquid crystal compounds. The proportion (content) of a liquid crystal compound is expressed in terms of weight percent (wt %) based on the weight of the liquid crystal composition. An additive such as an optically active compound, an antioxidant, an UV light absorbent, a dye, an antifoaming agent, a polymerizable compound, a polymerization initiator and a polymerization inhibitor is added to the composition, when necessary. The proportion (amount of addition) of the additive is expressed in terms of weight percent (wt %) based on the weight of the liquid crystal composition as in the case of the proportions of the liquid crystal compounds. Weight parts per million (ppm) may be occasionally used. The proportion of the polymerization initiator or the polymerization inhibitor is exceptionally expressed based on the weight of the polymerizable compound.

“The higher limit of the temperature range of a nematic phase” may be occasionally abbreviated as “maximum temperature.” “The lower limit of the temperature range of a nematic phase” may be occasionally abbreviated as “minimum temperature.” The expression “having a large specific resistance” means that the composition has a large specific resistance at room temperature and also at a temperature close to the maximum temperature of nematic phase in an initial stage, and that the composition has a large specific resistance at room temperature and also at a temperature close to the maximum temperature of nematic phase even after the device has been used for a long period of time. The expression “having a large voltage holding ratio” means that the device has a large voltage holding ratio at room temperature and also at a temperature close to the maximum temperature of nematic phase in an initial stage, and that the device has a large voltage holding ratio at room temperature and also at a temperature close to the maximum temperature of nematic phase even after the device has been used for a long period of time. The expression “increases the Δ∈” means that the value positively increases for the composition having a positive Δ∈, or that the value negatively increases for the composition having a negative Δ∈.

The expression “at least one of “A” may be replaced by “B”” means that the number of “A” is arbitrary. When the number of “A” is 1, the position of “A” is arbitrary, and when the number of “A” is 2 or more, the positions thereof can be selected without restriction. The same rule also applies to the expression “at least one of “A” is replaced by “B”.”

In formulae (1) to (5), the symbol A, B, C or the like surrounded by a hexagonal shape correspond to ring A, ring B, ring C or the like. In formula (5), an oblique line crossing the hexagonal shape of ring F means that the bonding position on the ring can be arbitrarily selected for a P²-Sp¹ group. The same rule also applies to a P²-Sp² group or the like in ring G or the like. A subscript such as f represents the number of groups to be bonded with ring F or the like. When f is 2, two P¹-Sp¹ groups exist on ring F. Two groups represented by P¹-Sp¹ may be identical or different. The same rule also applies to arbitrary two P¹-Sp¹ groups when f is larger than 2. The same rule also applies to any other group. A compound represented by formula (1) may be occasionally abbreviated as compound (1). The abbreviation is also applied to a compound represented by formula (2) or the like. Compound (1) means one compound or two or more compounds represented by formula (1). The symbol of terminal group R² is used for a plurality of compounds in the chemical formulas of the component compounds. In the compounds, two groups represented by arbitrary two R² may be identical or different. In one case, for example, R² of compound (1-1) is ethyl and R² of compound (1-2) is ethyl. In another case, R² of compound (1-1) is ethyl and R² of compound (1-2) is propyl. The same rule also applies to other symbols such as those of any other terminal groups. In formula (4), when d is 2, two rings D exist. In the compound, two rings represented by two rings D may be identical or different. The same rule also applies to arbitrary two rings D where d is larger than 2. The same rule also applies to other symbols such as Z³ and ring B.

Then, 2-fluoro-1,4-phenylene means the two divalent groups described below. Ina chemical formula, the fluorine may be leftward or rightward. The same rule also applies to other asymmetrical divalent ring group, such as tetrahydropyran-2,5-diyl.

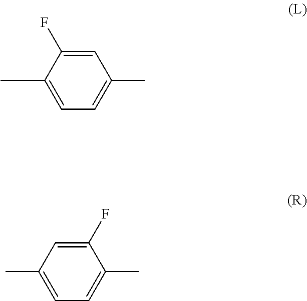

The invention includes the items described below.

Item 1 is a liquid crystal composition that has a negative dielectric anisotropy and contains at least one compound selected from the group consisting of compounds represented by formula (1) as a first component and at least one compound selected from the group consisting of compounds represented by formula (2) as a second component:

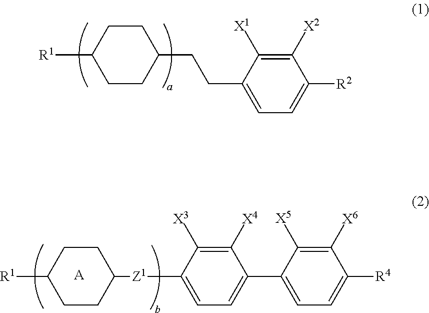

wherein in formulae (1) and (2), R¹ is alkenyl having 2 to 4 carbons; R² is alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen; R³ and R⁴ are independently alkyl having 1 to 12 carbons, alkoxy having 1 to 12 carbons, or alkyl having 1 to 12 carbons in which at least one hydrogen is replaced by halogen; ring A is 1,4-cyclohexylene, 1,4-cyclohexenylene, 1,4-phenylene, 1,4-phenylene in which at least one hydrogen is replaced by fluorine or chlorine, or tetrahydropyran-2,5-diyl; X¹ and X² are independently fluorine or chlorine; X³, X⁴, X⁵ and X⁶ are independently hydrogen or fluorine; Z¹ is a single bond, —CH₂CH₂—, —CH₂O—, —OCH₂—, —COO— or —OCO—; a is 1 or 2; and b is 0 or 1.

Item 2 is the liquid crystal composition of item 1 in which the first component contains at least one compound selected from the group consisting of compounds represented by formula (1-1) and formula (1-2):

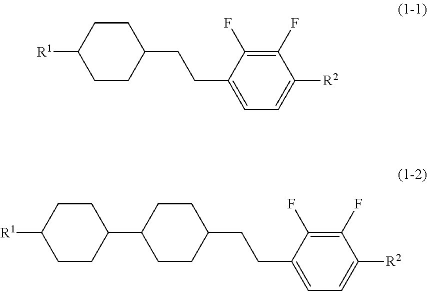

wherein in formulae (1-1) and (1-2), R¹ is alkenyl having 2 to 4 carbons; R² is alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen.

Item 3 is the liquid crystal composition of item 1 or 2 in which the second component contains at least one compound selected from the group consisting of compounds represented by formulae (2-1) to (2-10):

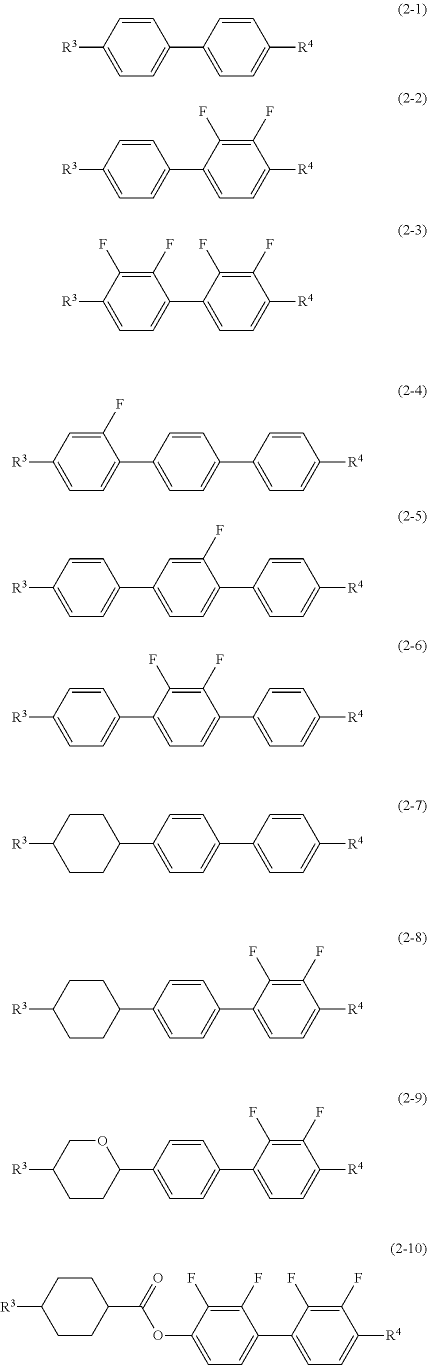

wherein in formulae (2-1) to (2-10), R³ and R⁴ are independently alkyl having 1 to 12 carbons, alkoxy having 1 to 12 carbons, or alkyl having 1 to 12 carbons in which at least one hydrogen is replaced by halogen.

Item 4 is the liquid crystal composition of any one of items 1 to 3 in which the proportion of the first component is in the range of 5 wt % to 50 wt % and the proportion of the second component is in the range of 5 wt % to 50 wt %, based on the weight of the liquid crystal composition.

Item 5 is the liquid crystal composition of any one of items 1 to 4 which further contains at least one compound selected from the group consisting of compounds represented by formula (3) as a third component:

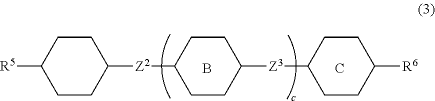

wherein in formula (3), R⁵ and R⁶ are independently alkyl having 1 to 12 carbons, alkoxy having 1 to 12 carbons, alkenyl having 2 to 12 carbons, alkyl having 1 to 12 carbons in which at least one hydrogen is replaced by halogen, or alkenyl having 2 to 12 carbons in which at least one hydrogen is replaced by halogen; ring B and ring C are independently 1,4-cyclohexylene, 1,4-phenylene, 2-fluoro-1,4-phenylene or 2,5-difluoro-1,4-phenylene; Z² and Z³ are independently a single bond, —CH₂CH₂—, —CH₂O—, —OCH₂—, —COO— or —OCO—; c is 0, 1 or 2; and ring B when c is 1 is 1,4-cyclohexylene.

Item 6 is the liquid crystal composition of item 5 in which the third component contains at least one compound selected from the group consisting of compounds represented by formulae (3-1) to (3-9):

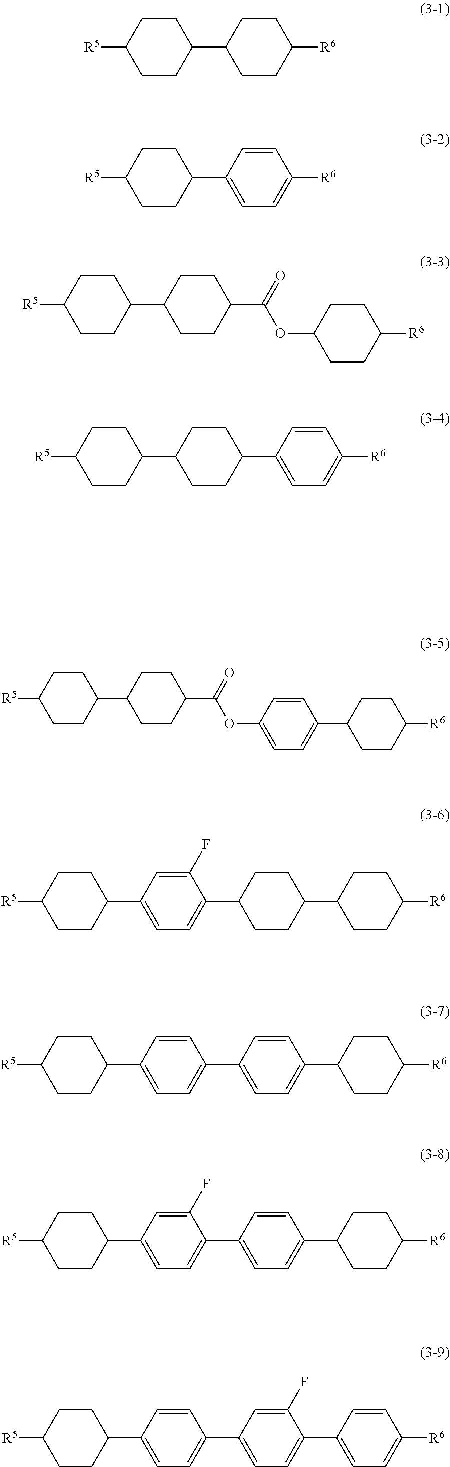

wherein in formulae (3-1) to (3-9), R⁵ and R⁶ are independently alkyl having 1 to 12 carbons, alkoxy having 1 to 12 carbons, alkenyl having 2 to 12 carbons, alkyl having 1 to 12 carbons in which at least one hydrogen is replaced by halogen, or alkenyl having 2 to 12 carbons in which at least one hydrogen is replaced by halogen.

Item 7 is the liquid crystal composition of item 5 or 6 in which the proportion of the third component is in the range of 10 to 90 wt % based on the weight of the liquid crystal composition.

Item 8 is the liquid crystal composition of any one of items 1 to 7 which further contains at least one compound selected from the group consisting of compounds represented by formula (4) as a fourth component:

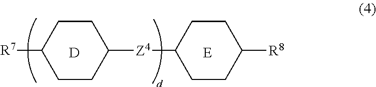

wherein in formula (4), R⁷ and R⁸ are independently alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen; ring D is 1,4-cyclohexylene, 1,4-cyclohexenylene or tetrahydropyran-2,5-diyl; ring E is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl; Z⁴ is a single bond, —CH₂O—, —OCH₂—, —COO— or —OCO—; and d is 1, 2 or 3.

Item 9 is the liquid crystal composition of item 8 in which the forth component contains at least one compound selected from the group consisting of compounds represented by formulae (4-1) to (4-10):

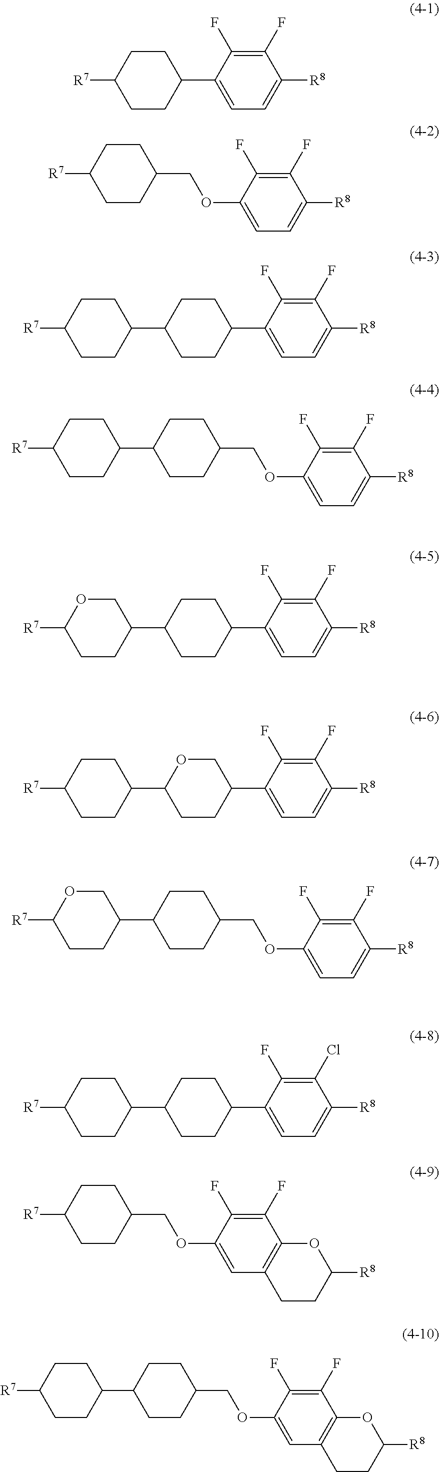

wherein in formulae (4-1) to (4-10), R⁷ and R⁸ are independently alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen.

Item 10 is the liquid crystal composition of item 8 or 9 in which the proportion of the fourth component is in the range of 5 wt % to 70 wt % based on the weight of the liquid crystal composition.

Item 11 is the liquid crystal composition of any one of items 1 to 10 which further contains at least one polymerizable compound selected from the group consisting of compounds represented by formula (5) as an additive component:

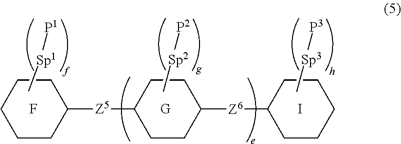

wherein in formula (5), ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen; ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen; Z⁵ and Z⁶ are independently a single bond or alkylene having 1 to 10 carbons, and in the alkylene, at least one —CH₂— may be replaced by —O—, —CO—, —COO— or —OCO—, at least one —CH₂—CH₂— may be replaced by —CH═CH—, —C(CH₃)═CH—, —CH═C(CH₃)— or —C(CH₃)═C(CH₃)—, and in the groups, at least one hydrogen may be replaced by fluorine or chlorine; P¹, P² and P³ are independently a polymerizable group; Sp¹, Sp² and Sp³ are independently a single bond or alkylene having 1 to 10 carbons, and in the alkylene, at least one —CH₂— may be replaced by —O—, —COO—, —OCO— or —OCOO—, at least one —CH₂—CH₂— may be replaced by —CH═CH— or —C≡C—, and in the groups, at least one hydrogen may be replaced by fluorine or chlorine; e is 0, 1 or 2; f, g and h are independently 0, 1, 2, 3 or 4; and the sum of f, g and h is 1 or more.

Item 12 is the liquid crystal composition of item 11 in which P¹, P² and P³ in formula (5) are independently a polymerizable group selected from the group consisting of groups represented by formulae (P-1) to (P-6):

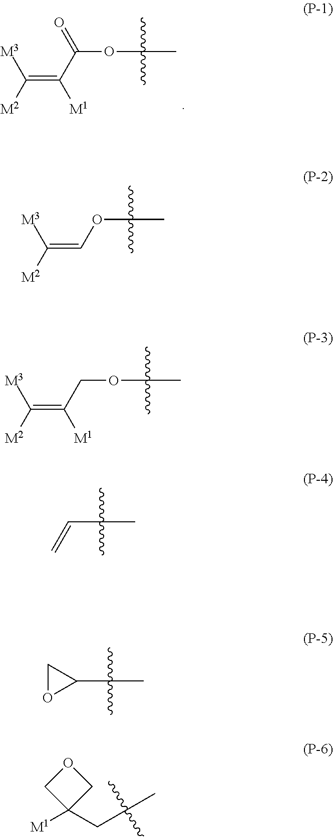

wherein in formulae (P-1) to (P-6), M¹, M² and M³ are independently hydrogen, fluorine, alkyl having 1 to 5 carbons, or alkyl having 1 to 5 carbons in which at least one hydrogen is replaced by halogen; and when all of the f piece(s) of P¹ and the h piece(s) of P³ are groups represented by formula (P-4), in formula (5), at least one of the f piece(s) of Sp¹ and the h piece(s) of Sp³ is alkylene in which at least one —CH₂— is replaced by —O—, —COO—, —OCO— or —OCOO—.

Item 13 is the liquid crystal composition of item 11 or 12 in which the additive component contains at least one polymerizable compound selected from the group consisting of compounds represented by formulae (5-1) to (5-27):

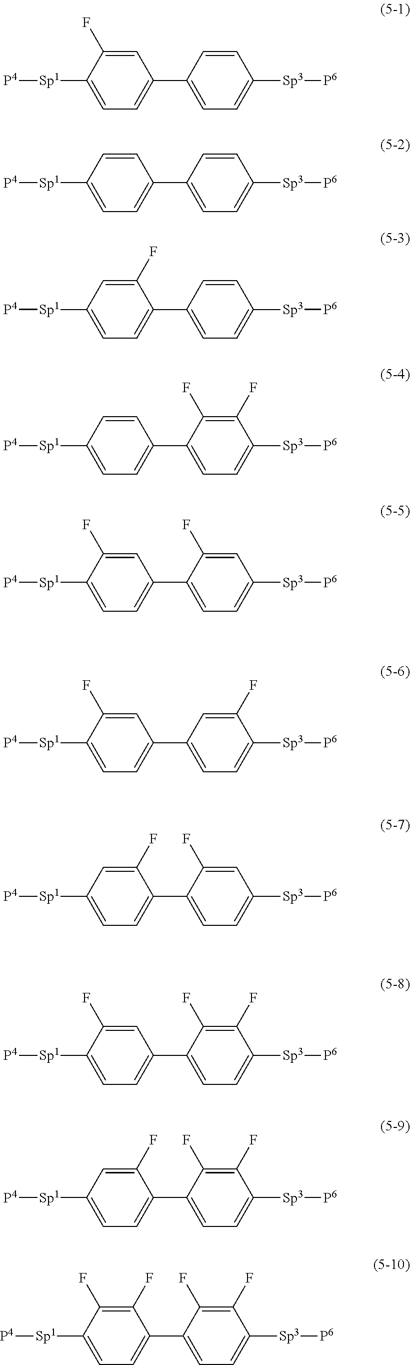

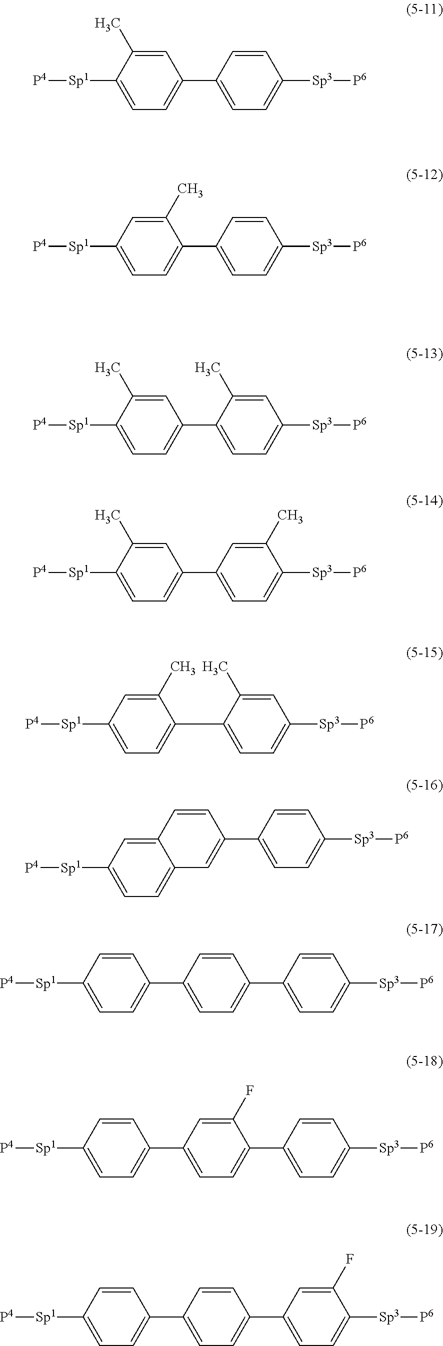

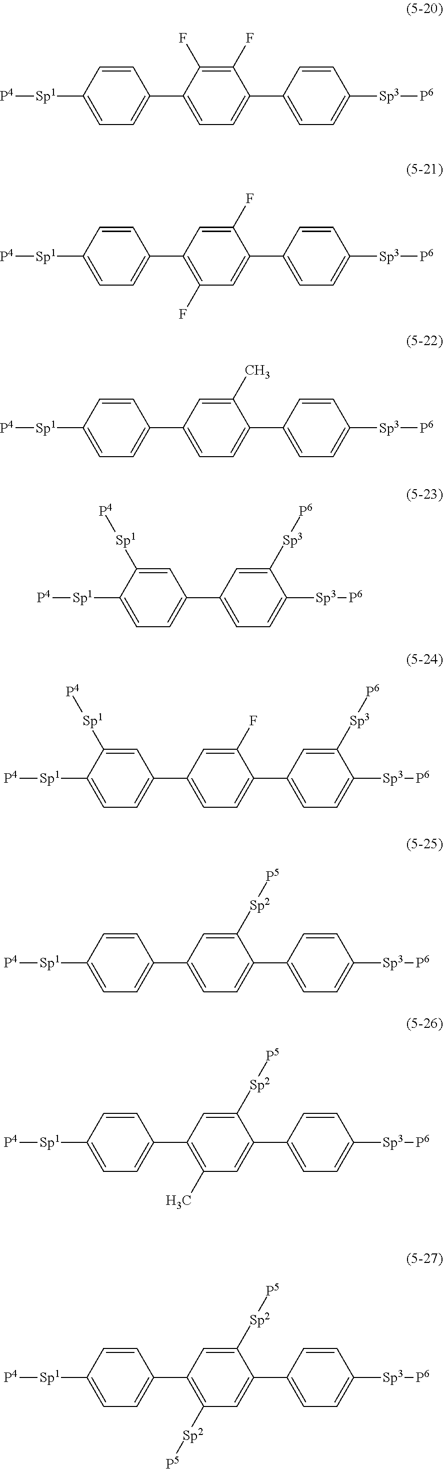

wherein in formulae (5-1) to (5-27), P⁴, P⁵ and P⁶ are independently a polymerizable group selected from the group consisting of groups represented by formulae (P-1) to (P-3);

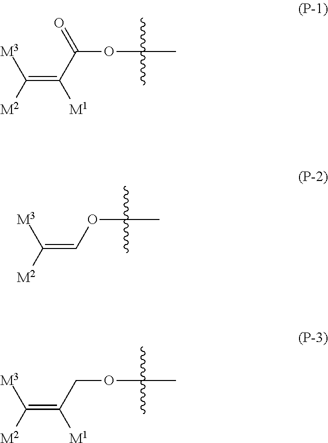

wherein in formulae (P-1) to (P-3), M¹, M² and M³ are independently hydrogen, fluorine, alkyl having 1 to 5 carbons, or alkyl having 1 to 5 carbons in which at least one hydrogen is replaced by halogen; and in formulae (5-1) to (5-27), Sp¹, Sp² and Sp³ are independently a single bond or alkylene having 1 to 10 carbons, and in the alkylene, at least one —CH₂— may be replaced by —O—, —COO—, —OCO— or —OCOO—, at least one —CH₂—CH₂— may be replaced by —CH═CH— or —C≡C—, and in the groups, at least one hydrogen may be replaced by fluorine or chlorine.

Item 14 is the liquid crystal composition of any one of items 11 to 13 in which the proportion of addition of the additive component is in the range of 0.03 wt % to 10 wt % based on the weight of the liquid crystal composition.

Item 15 is a liquid crystal display device which includes the liquid crystal composition of any one of items 1 to 14.

Item 16 is the LCD device of item 15 of which the operating mode is an IPS mode, a VA mode, an FFS mode or an FPA mode, and the driving mode is an active matrix mode.

Item 17 is a PSA-mode LCD device which includes the liquid crystal composition of any one of items 11 to 14, or a composition obtained by polymerizing the polymerizable compound in the liquid crystal composition.

Item 18 is use of the liquid crystal composition of any one of items 1 to 14 in an LCD device.

Item 19 is use of the liquid crystal composition of any one of items 11 to 14 in a PSA-mode LCD device.

The invention further includes the following items: a) the composition which further contains at least one additive such as an optically active compound, an antioxidant, a UV light absorbent, a dye, an antifoaming agent, a polymerizable compound, a polymerization initiator and a polymerization inhibitor; b) an AM device including the composition; c) a PSA-mode AM device including the composition further containing the polymerizable compound; d) a PSA-mode AM device including the composition in which the polymerizable compound in the composition is polymerized; e) a device including the composition and having the PC, TN, STN, ECB, OCB, IPS, VA, FFS or FPA mode; f) a transmissive device including the composition; g) use of the composition as the composition having a nematic phase; and h) use as an optically activity composition by adding an optically active compound to the composition.

The composition of the invention will be described in the following order. First, the constitution of the component compounds in the composition is described. Second, main characteristics of the component compounds and main effects of the compounds on the composition are described. Third, the combination of the components in the composition, preferred proportions of the components and the bases thereof are described. Fourth, preferred embodiments of the component compounds are described. Fifth, preferred component compounds are shown. Sixth, additives that may be added to the composition are described. Seventh, methods for synthesizing the component compounds are described. Last, the application of the composition is described.

First, the constitution of the component compounds in the composition is described. The composition of the invention is classified into composition A and composition B. Composition A may further contain any other liquid crystal compound, additive or the like in addition to the compound selected from compounds (1), (2), (3), (4) and (5). “Any other liquid crystal compound” means a liquid crystal compound different from compounds (1), (2), (3) and (4). Such a compound is mixed in the composition for further adjusting the characteristics. The additives include an optically active compound, an antioxidant, a UV light absorbent, a dye, an antifoaming agent, a polymerizable compound, a polymerization initiator and a polymerization inhibitor.

Composition B consists essentially of compounds selected from compounds (1), (2), (3), (4) and (5). The term “essentially” means that the composition may contain the additive but does not contain any other liquid crystal compound. Composition B has a smaller number of components than composition A has. Composition B is preferred to composition A in view of cost reduction. Composition A is preferred to composition B in view of possibility of further adjusting characteristics by mixing other liquid crystal compound.

Second, the main characteristics of the component compounds and the main effects of the compounds on the characteristics of the composition are described. The main characteristics of the component compounds are summarized in Table 2 based on advantageous effects of the invention. In Table 2, the symbol “L” stands for “large” or “high,” “M” stands for “medium,” and “S” stands for “small” or “low.” The symbols L, M and S represent a classification based on a qualitative comparison between the component compounds,

TABLE 2
Characteristics of Compounds

| Compound | (1) | (2) | (3) | (4) |
|---|---|---|---|---|
| Maximum temperature | S to M | S to M | S to L | S to M |
| Viscosity | M to L | M to L | S to M | M to L |
| Optical anisotropy | S to M | L | S to L | M to L |
| Dielectric anisotropy | L¹⁾ | 0 to L¹⁾ | 0 | L¹⁾ |
| Specific resistance | L | L | L | L |

1) The Δ∈ value is negative, and the symbol shows magnitude of its absolute value.

Upon mixing the component compounds in the composition, the main effects of the component compounds on the characteristics of the composition are as described below. Compound (1) increases the dielectric anisotropy. Compound (2) increases the optical anisotropy. Compound (3) decreases the viscosity and increases the maximum temperature. Compound (4) increases the dielectric anisotropy and decreases the minimum temperature. Compound (5) is polymerized to give a polymer, and the polymer shortens the response time of the device and reduces image persistence.

Third, the combination of components in the composition, preferred proportions of the component compounds and the bases thereof are described. A preferred combination of the components in the composition is a combination of the 1^{st} component and the 2^{nd} component, a combination of the 1^{st} component, the 2^{nd} component and the 3^{rd} component, a combination of the 1^{st} component, the 2^{nd} component and the 4^{th} component, a combination of the 1^{st} component, the 2^{nd} component and the additive component, a combination of the 1^{st} component, the 2^{nd} component, the 3^{rd} component and the 4^{th} component, a combination of the 1^{st} component, the 2^{nd} component, the 3^{rd} component and the additive component, a combination of the 1^{st} component, the 2^{nd} component, the 4^{th} component and the additive component, or a combination of the 1^{st} component, the 2^{nd} component, the 3^{rd} component, the 4^{th} component and the additive component. A further preferred combination is the combination of the 1^{st} component, the 2^{nd} component and the 3^{rd} component, the combination of the 1^{st} component, the 2^{nd} component, the 3^{rd} component and the 4^{th} component, the combination of the 1^{st} component, the 2^{nd} component, the 3^{rd} component and the additive component, or the combination of the 1^{st}, the 2^{nd}, the 3^{rd} the 4^{th} and the additive components.

A preferred proportion of the first component is about 5 wt % or more for increasing Δ∈, and about 50 wt % or less for decreasing the minimum temperature. A further preferred proportion is in the range of about 5 wt % to about 40 wt %. A particularly preferred proportion is in the range of about 5 wt % to about 30 wt %.

A preferred proportion of the second component is about 5 wt % or more for increasing Δn, and about 50 wt % or less for decreasing the minimum temperature. A further preferred proportion is in the range of about 5 wt % to about 40 wt %. A particularly preferred proportion is in the range of about 5 wt % to about 35 wt %.

A preferred proportion of the third component is about 10 wt % or more for increasing the maximum temperature or decreasing the viscosity, and about 90 wt % or less for increasing the dielectric anisotropy. A further preferred proportion is in the range of about 20 wt % to about 70 wt %. A particularly preferred proportion is in the range of about 25 wt % to about 60 wt %.

A preferred proportion of the fourth component is about 5 wt % or more for increasing Δ∈, and about 70 wt % or less for decreasing the minimum temperature. A further preferred proportion is in the range of about 5 wt % to about 50 wt %. A particularly preferred proportion is in the range of about 5 wt % to about 40 wt %.

Compound (5) is added to the composition for adapting the composition for the PSA-mode device. A preferred proportion of addition of the additive is about 0.03 wt % or more for aligning the liquid crystal molecules and about 10 wt % or less for preventing poor display of the device, based on the weight of the liquid crystal composition. A further preferred proportion of addition is in the range of about 0.1 wt % to about 2 wt %. A particularly preferred proportion of addition is in a range of about 0.2 wt % to about 1 wt %.

Fourth, the preferred embodiment of the component compounds are described. In formulae (1), (2), (3) and (4), R¹ is alkenyl having 2 to 4 carbons. R² is alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen. Preferred R² is alkyl having 1 to 12 carbons for increasing the stability, or alkoxy having 1 to 12 carbons for increasing Δ∈. R³ and R⁴ are independently alkyl having 1 to 12 carbons, alkoxy having 1 to 12 carbons, or alkyl having 1 to 12 carbons in which at least one hydrogen is replaced by halogen. Preferred R³ or R⁴ is alkyl having 1 to 12 carbons for increasing the stability, or alkoxy having 1 to 12 carbons for increasing Δ∈. R⁵ and R⁶ are independently alkyl having 1 to 12 carbons, alkoxy having 1 to 12 carbons, alkenyl having 2 to 12 carbons, alkyl having 1 to 12 carbons in which at least one hydrogen is replaced by halogen, or alkenyl having 2 to 12 carbons in which at least one hydrogen is replaced by halogen. Preferred R⁵ or R⁶ is alkenyl having 2 to 12 carbons for decreasing the viscosity, or alkyl having 1 to 12 carbons for increasing the stability. R⁷ and R⁸ are independently alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen. Preferred R⁷ or R⁸ is alkyl having 1 to 12 carbons for increasing the stability, or alkoxy having 1 to 12 carbons for increasing Δ∈.

Alkyl in R¹ to R⁸ is straight alkyl or branched alkyl, but includes no cyclic alkyl. Straight alkyl is preferred to branched alkyl. The same rule also applies to alkoxy, alkenyl, alkenyloxy, alkyl in which hydrogen is replaced by halogen and alkenyl in which hydrogen is replaced by halogen. Halogens include fluorine, chlorine, bromine and iodine. Preferred halogens include fluorine and chlorine. Further preferred halogen is fluorine.

Preferred examples of alkyl include methyl, ethyl, propyl, butyl, pentyl, hexyl, heptyl and octyl. Further preferred examples of alkyl include ethyl, propyl, butyl, pentyl and heptyl for decreasing the viscosity.

Preferred examples of alkyl in which at least one hydrogen is replaced by halogen include fluoromethyl, 2-fluoroethyl, 3-fluoropropyl, 4-fluorobutyl, 5-fluoropentyl, 6-fluorohexyl, 7-fluoroheptyl and 8-fluorooctyl. Further preferred examples include 2-fluoroethyl, 3-fluoropropyl, 4-fluorobuty and 5-fluoropentyl for increasing the dielectric anisotropy.

Preferred examples of alkoxy include methoxy, ethoxy, propoxy, butoxy, pentyloxy, hexyloxy and heptyloxy. Further preferred examples of alkoxy include methoxy and ethoxy for decreasing the viscosity.

Preferred examples of alkenyl include vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl and 5-hexenyl. Further preferred examples of alkenyl include vinyl, 1-propenyl, 3-butenyl and 3-pentenyl for decreasing the viscosity. A preferred configuration of —CH═CH— in the alkenyl depends on the position of the double bond. Trans is preferred for alkenyl such as 1-propenyl, 1-butenyl, 1-pentenyl, 1-hexenyl, 3-pentenyl and 3-hexenyl for decreasing the viscosity, or the like. Cis is preferred for alkenyl such as 2-butenyl, 2-pentenyl and 2-hexenyl. Among the alkenyl, straight alkenyl is preferred to branched alkenyl.

Preferred examples of alkenyloxy include vinyloxy, allyloxy, 3-butenyloxy, 3-pentenyloxy and 4-pentenyloxy. Further preferred examples of alkenyloxy include allyloxy and 3-butenyloxy for decreasing the viscosity.

Preferred examples of alkenyl in which at least one hydrogen is replaced by halogen include 2,2-difluorovinyl, 3,3-difluoro-2-propenyl, 4,4-difluoro-3-butenyl, 5,5-difluoro-4-pentenyl and 6,6-difluoro-5-hexenyl. Further preferred examples include 2,2-difluorovinyl and 4,4-difluoro-3-butenyl for decreasing the viscosity.

Ring A includes 1,4-cyclohexylene, 1,4-cyclohexenylene, 1,4-phenylene, 1,4-phenylene in which at least one hydrogen is replaced by fluorine or chlorine, or tetrahydropyran-2,5-diyl. Preferred examples of “1,4-phenylene in which at least one hydrogen is replaced by fluorine or chlorine” include 2-fluoro-1,4-phenylene, 2,3-difluoro-1,4-phenylene and 2-chloro-3-fluoro-1,4-phenylene. Preferred ring A is 1,4-cyclohexylene for decreasing the viscosity, tetrahydropyran-2,5-diyl for increasing Δ∈, or 1,4-phenylene for increasing Δn. With regard to the configuration of 1,4-cyclohexylene, trans is preferred to cis for increasing the maximum temperature. Tetrahydropyran-2,5-diyl is

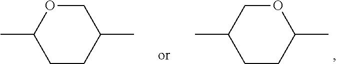

and preferably

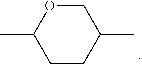

Ring B and ring C are independently 1,4-cyclohexylene, 1,4-phenylene, 2-fluoro-1,4-phenylene or 2,5-difluoro-1,4-phenylene, and when c is 1, ring B is 1,4-cyclohexylene. Preferred ring B or ring C is 1,4-cyclohexylene for decreasing the viscosity or increasing the maximum temperature, or 1,4-phenylene for decreasing the minimum temperature. Ring D is 1,4-cyclohexylene, 1,4-cyclohexenylene or tetrahydropyran-2,5-diyl. Preferred ring Dis 1,4-cyclohexylene for decreasing viscosity, or tetrahydropyran-2,5-diyl for increasing Δ∈. Ring E is 2,3-difluoro-1,4-phenylene, 2-chloro-3-fluoro-1,4-phenylene, 2,3-difluor-5-methyl-1,4-phenylene, 3,4,5-trifluoronaphthalene-2,6-diyl or 7,8-difluorochroman-2,6-diyl. Preferred ring E is 2,3-difluoro-1,4-phenylene for decreasing the viscosity, 2-chloro-3-fluoro-1,4-phenylene for decreasing Δn, or 7,8-difluorochroman-2,6-diyl for increasing Δ∈.

Z¹, Z², Z and Z⁴ are independently a single bond, —CH₂CH₂—, —CH₂O—, —OCH₂—, —COO— or —OCO—. Preferred Z¹, Z² or Z³ is a single bond for increasing the stability. Preferred Z⁴ is a single bond for decreasing the viscosity, —CH₂CH₂— for decreasing the minimum temperature, or —CH₂O— for increasing the dielectric anisotropy.

X¹ and X² are independently fluorine or chlorine. Preferred X¹ or X² is fluorine for decreasing the viscosity. X³, X⁴, X⁵ and X⁶ are independently hydrogen, fluorine or chlorine. Preferred X³, X⁴, X⁵ or X⁶ is hydrogen for decreasing the viscosity, or is fluorine for increasing the dielectric anisotropy.

Then, a is 1 or 2. Preferred a is 1 for decreasing the viscosity, or 2 for increasing the maximum temperature. Then, b is 0 or 1. Preferred b is 0 for decreasing the viscosity. Then, c is 0, 1 or 2. Preferred c is 0 for decreasing the viscosity, or is 1 or 2 for increasing the maximum temperature. Then, d is 1, 2 or 3. Preferred d is 1 for decreasing the viscosity, or is 2 or 3 for increasing the maximum temperature.

In formula (5) and formulae (5-1) to (5-27), Sp¹, Sp² and Sp³ are independently a single bond or alkylene having 1 to 10 carbons, and in the alkylene, at least one —CH₂— may be replaced by —O—, —COO—, —OCO— or —OCOO—, at least one —CH₂—CH₂— may be replaced by —CH═CH— or —C≡C—, and in the groups, at least one hydrogen may be replaced by fluorine or chlorine. Preferred Sp¹, Sp² or Sp³ is a single bond.

In formula (5), P¹, P² and P³ are a polymerizable group. Preferred P¹, P² or P³ is a polymerizable group selected from the group consisting of groups represented by formulae (P-1) to (P-6). Further preferred P¹, P² or P³ is group (P-1) or (P-2). Particularly preferred group (P-1) is —OCO—CH═CH₂ or —OCO—C(CH₃)═CH₂. A wavy line in groups (P-1) to (P-6) indicates the site to be bonded.

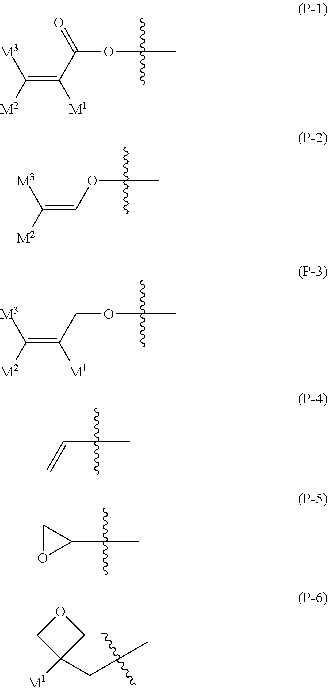

In groups (P-1) to (P-6), M¹, M² and M³ are independently hydrogen, fluorine, alkyl having 1 to 5 carbons, or alkyl having 1 to 5 carbons in which at least one hydrogen is replaced by halogen. Preferred M¹, M² or M³ is hydrogen or methyl for increasing reactivity. Further preferred M¹ is methyl, and further preferred M² or M³ is hydrogen. When all of the f piece(s) of P¹, the e×g piece(s) of P² and the h piece(s) of P³ are group (P-1), arbitrary two M¹, M² or M³ in P¹, P² and P³ may be identical or different. The same rule applies to a case where all of them are group (P-2) or (P-3).

When all of the f piece(s) of P¹ and the h piece(s) of P³ are group (P-4), at least one of the f piece(s) of Sp¹ and the h piece(s) of Sp³ is alkylene in which at least one —CH₂— is replaced by —O—, —COO—, —OCO— or —OCOO—. More specifically, a case where all of the f piece(s) of P¹ and the h piece(s) of P³ are alkenyl such as 1-propenyl is excluded.

In formulae (5-1) to (5-27), P⁴, P⁵ and P are independently a group represented by formula (P-1), (P-2) or (P-3). Preferred P⁴, P⁵ or P⁶ is group (P-1) or (P-2). Further preferred group (P-1) is —OCO—CH═CH₂ or —OCO—C(CH₃)═CH₂. A wavy line in groups (P-1) to (P-3) indicates the site to be bonded.

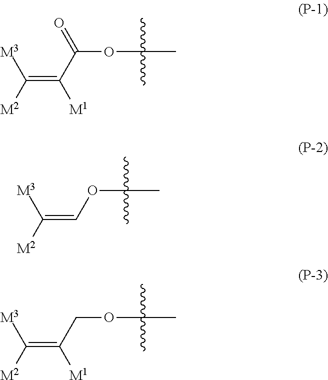

When all of one or two P⁴, one or two P⁵ and one or two P⁶ are group (P-1), arbitrary two M¹, M² or M³ in P⁴, P⁵ and P⁶ may be identical or different. The same rule applies to a case where all of them are group (P-2) or group (P-3).

In formula (5), ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen. Preferred ring F or ring I is phenyl. Ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 3-dioxane-2,5-diyl, pyrimidine-2,5-diyl or pyridine-2,5-diyl, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen. Preferred ring G is 1,4-phenylene or 2-fluoro-1,4-phenylene.

Z⁵ and Z⁶ are independently a single bond or alkylene having 1 to 10 carbons, and in the alkylene, at least one —CH₂— may be replaced by —O—, —CO—, —COO— or —OCO—, at least one —CH₂—CH₂— may be replaced by —CH═CH—, —C(CH₃)═CH—, —CH═C(CH₃)— or —C(CH₃)═C(CH₃)—, and in the groups, at least one hydrogen may be replaced by fluorine or chlorine. Preferred Z⁵ or Z⁶ is a single bond, —CH₂CH₂—, —CH₂O—, —OCH₂—, —COO— or —OCO—. Further preferred Z⁵ or Z⁶ is a single bond.

Further, e is 0, 1 or 2. Preferred e is 0 or 1. Then, f, g and h are independently 0, 1, 2, 3 or 4, and the sum of f, g and h is 1 or more. Preferred f, g or h is 1 or 2.

Fifth, preferred component compounds are shown. Preferred compounds (1) include compounds (1-1) and compound (1-2) as described in item 2.

Preferred compounds (2) include compounds (2-1) to (2-10) as described in item 3. It is preferred that at least one compound in the second component is compound (2-1), (2-2), (2-4), (2-5), (2-7) or (2-8) among the compounds. It is also preferred that at least two compounds in the second component are a combination of compounds (2-1) and (2-2), a combination of compounds (2-1) and (2-8) or a combination of compounds (2-2) and (2-8).

Preferred compounds (3) include compounds (3-1) to (3-9) as described in item 6. It is preferred that at least one compound in the third component is compound (3-1), (3-2) or (3-4) among the compounds. It is also preferred that at least two compounds in the third component are a combination of compounds (3-1) and (3-2) or a combination of compounds (3-1) and (3-4).

Preferred compounds (4) include compounds (4-1) to (4-10) as described in item 9. It is preferred that at least one compound in the fourth component is compound (4-1), (4-2), (4-3) or (4-4) among the compounds. It is also preferred that at least two compounds in the fourth component are a combination of compounds (4-1) and (4-3) or a combination of compounds (4-2) and (4-4).

Preferred compounds (5) include compounds (5-1) to (5-27) as described in item 13. It is preferred that at least one compound in the additive component is compound (5-1), (5-2), (5-24), (5-25), (5-26) or (5-27) among the compounds. It is also preferred that at least two compounds in the additive component are a combination of compounds (5-1) and (5-2), a combination of compounds (5-1) and (5-18), a combination of compounds (5-2) and (5-24), a combination of compounds (5-2) and (5-25), a combination of compounds (5-2) and (5-26), a combination of compounds (5-25) and (5-26) or a combination of compounds (5-18) and (5-24). In groups (P-1) to (P-3), preferred M¹, M² or M³ is hydrogen or methyl. Preferred Sp¹, Sp² or Sp³ is a single bond, —CH₂CH₂—, —CH₂O—, —OCH₂—, —COO—, —OCO—, —CO—CH═CH— or —CH═CH—CO—.

Sixth, the additives that may be added to the composition are described. Such additives include an optically active compound, an antioxidant, a UV light absorbent, a dye, an antifoaming agent, a polymerizable compound, a polymerization initiator and a polymerization inhibitor. The optically active compound is added to the composition for inducing a helical structure in the liquid crystal to give a twist angle. Examples of such a compound include compounds (6-1) to (6-5). A preferred proportion of the optically active compound is about 5 wt % or less. A further preferred proportion is in the range of about 0.01 wt % to about 2 wt %.

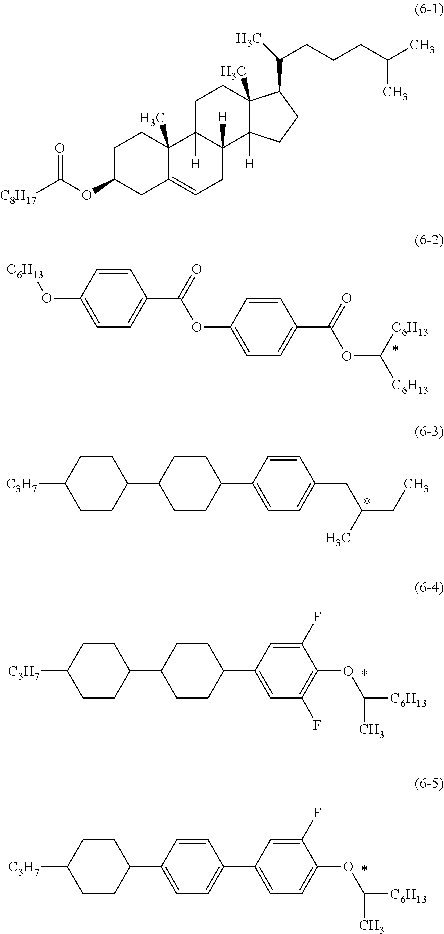

The antioxidant is added to the composition for preventing a decrease in the specific resistance caused by heating in air, or for maintaining a large voltage holding ratio at room temperature and also at a temperature close to the maximum temperature even after the device has been used for a long period of time. Preferred examples of the antioxidant include compound (7) where n is an integer from 1 to 9.

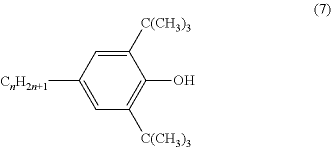

For compound (7), preferred n is 1, 3, 5, 7 or 9. Further preferred n is 7. Compound (7) of n=7 is effective in maintaining a large voltage holding ratio at room temperature and also at a temperature close to the maximum temperature even after the device has been used for a long period of time because such compound (7) has a small volatility. A preferred proportion of the antioxidant is about 50 ppm or more for achieving the effect thereof, and about 600 ppm or less for avoiding a decrease in the maximum temperature or avoiding an increase in the minimum temperature. A further preferred proportion ranges from about 100 ppm to about 300 ppm.

Preferred examples of the UV light absorbent include a benzophenone derivative, a benzoate derivative and a triazole derivative. A light stabilizer such as an amine having steric hindrance is also preferred. A preferred proportion of the UV light absorbent or the stabilizer is about 50 ppm or more for achieving the effect thereof, and about 10,000 ppm or less for avoiding a decrease in the maximum temperature or avoiding an increase in the minimum temperature. A further preferred proportion is in the range of about 100 ppm to about 10,000 ppm.

A dichroic dye such as an azo dye or an anthraquinone dye is added to the composition to adapt it to a device having a guest host (GH) mode. A preferred proportion of the dye is in the range of about 0.01 wt % to about 10 wt %. The antifoaming agent such as dimethyl silicone oil or methyl phenyl silicone oil is added to the composition for preventing foam formation. A preferred proportion of the antifoaming agent is about 1 ppm or more for achieving the effect thereof, and about 1000 ppm or less for preventing poor display. A further preferred proportion is in the range of about 1 ppm to about 500 ppm.

The polymerizable compound is used to adapt the composition to a PSA-mode device. Compound (5) is suitable for the purpose. Other polymerizable compound that is different from compound (5) may be added to the composition together with compound (5). Preferred examples of the polymerizable compounds include acrylate, methacrylate, a vinyl compound, a vinyloxy compound, propenyl ether, an epoxy compound (oxirane and oxetane) and vinyl ketone. Further preferred examples include an acrylate derivative and a methacrylate derivative. A preferred proportion of compound (5) is in the range of about 10 wt % or more based on the total weight of the polymerizable compound. A further preferred proportion is about 50 wt % or more. A particularly preferred proportion is about 80 wt % or more. A most preferred proportion is about 100 wt %.

The polymerizable compound such as compound (5) is polymerized by irradiation with UV light, and may be polymerized in the presence of a suitable initiator such as a photopolymerization initiator. Suitable conditions for polymerization, suitable types of the initiator and suitable amounts thereof are known to those of ordinary skill in the art and are described in literature. For example, Irgacure 651™ (BASF), Irgacure 184™ (BASF) or Darocur 1173™ (BASF), each being a photoinitiator, is suitable for radical polymerization. A preferred proportion of the photopolymerization initiator is in the range of about 0.1 wt % to about 5 wt % based on the total weight of the polymerizable compound. A further preferred proportion is in the range of about 1 wt % to about 3 wt % based on the same.

When a polymerizable compound such as compound (5) is stored, a polymerization inhibitor may be added thereto for preventing polymerization. The polymerizable compound is ordinarily added to the composition without removing the polymerization inhibitor. Examples of the polymerization inhibitor include hydroquinone, a hydroquinone derivative such as methylhydroquinone, 4-tert-butylcatechol, 4-methoxyphenol and phenothiazine.

Seventh, methods for synthesizing the component compounds are described. The compounds can be prepared by known synthetic methods exemplified below. Compound (1-1) may be prepared by the method described in JP2002-193852A. Compound (2-7) may be prepared by the method described in JP S57-114532 A. Compound (3-1) may be prepared by the method described in JP S59-176221 A. Compound (4-1) may be prepared by the method described in JP H2-503441 A. Compound (5-18) may be prepared by the method described in JP H7-101900A. A compound represented by formula (7) of n=1 is available from Sigma-Aldrich Corporation. Compound (7) of n=7 and so forth may be prepared by the method described in U.S. Pat. No. 3,660,505 B.

Any compounds whose synthetic methods are not described above can be prepared by the methods described in books such as Organic Syntheses (John Wiley & Sons, Inc.), Organic Reactions (John Wiley & Sons, Inc.), Comprehensive Organic Synthesis (Pergamon Press) and New Experimental Chemistry Course (Maruzen Co., Ltd.). The composition is prepared by a publicly known method using the thus obtained compounds. For example, the component compounds are mixed and dissolved in each other by heating.

Last, the application of the composition is described. The composition mainly has a minimum temperature of about −10° C. or lower, a maximum temperature of about 70° C. or higher, and an optical anisotropy in the range of about 0.07 to about 0.20. The device including the composition has a large voltage holding ratio. The composition is suitable for use in the AM device. The composition is particularly suitable for use in a transmissive AM device. The composition having an optical anisotropy in the range of about 0.08 to about 0.25 and further the composition having an optical anisotropy in the range of about 0.10 to about 0.30 may be prepared by controlling the ratio of the component compounds or by mixing other liquid crystal compound. The composition can be used as a composition having a nematic phase or as an optically active composition by adding an optically active compound.

The composition can be used for the AM device. The composition can also be used for a PM device. The composition can be used for an AM device and a PM device both having a mode such as PC, TN, STN, ECB, OCB, IPS, FFS, VA or FPA. Use for an AM device of the TN, OCB, IPS or FFS mode is particularly preferred. In an AM device of the IPS or FFS mode, alignment of liquid crystal molecules when no voltage is applied may be parallel or vertical to a glass substrate. The devices may be of a reflective type, a transmissive type or a transflective type. Use for the transmissive device is preferred. The composition can also be used for an amorphous silicon-TFT device or a polysilicon-TFT device. The composition can also be used for a nematic curvilinear aligned phase (NCAP) device prepared by microencapsulating the composition, or for a polymer dispersed (PD) device in which a three-dimensional network-polymer is formed in the composition.

### EXAMPLES

The invention will be described in more details by way of Examples, but is not restricted thereto. For example, the invention may include a mixture of the composition of Example 1 and that of Example 2, or a mixture in which at least two compositions in Examples were mixed. A compound synthesized was identified by a method such as an NMR analysis. Characteristics of the compound and the composition were measured by methods described below.

NMR analysis: DRX-500 made by Bruker BioSpin Corporation was used for the measurement. In a ¹H-NMR measurement, a sample was dissolved in a deuterated solvent such as CDCl₃, and measurement was carried out under conditions of room temperature, 500 MHz and 16 times of accumulation. Tetramethylsilane was used as an internal standard. In ¹⁹F-NMR measurement, measurement was carried out under conditions of 24 times of accumulation using CFCl₃ as an internal standard. In explaining an NMR spectrum, s, d, t, q, quin, sex and m stand for a singlet, a doublet, a triplet, a quartet, a quintet, a sextet and a multiplet, respectively, and br means being broad.

Gas chromatographic analysis: GC-14B Gas Chromatograph made by Shimadzu Corporation was used for the measurement. The carrier gas was helium (2 mL/min). The sample injector and the detector (FID) were set to 280° C. and 300° C., respectively. A capillary column DB-1 (length: 30 m, bore: 0.32 mm, film thickness: 0.25 μm; dimethylpolysiloxane as a stationary phase, non-polar) made by Agilent Technologies, Inc. was used to separate component compounds. After the column was kept at 200° C. for 2 min, it was heated to 280° C. at a rate of 5° C./min. A sample was prepared in an acetone solution (0.1 wt %), and then 1 μL of the solution was injected into the sample injector. The recorder was C-R5A Chromatopac made by Shimadzu Corporation or an equivalent thereof. The resulting gas chromatogram showed a retention time of a peak and a peak area corresponding to each of the component compounds.

As a solvent for diluting the sample, chloroform, hexane or the like may also be used. The following capillary columns may also be used to separate the component compounds: HP-1 (length: 30 m, bore: 0.32 mm, film thickness: 0.25 μm) made by Agilent Technologies, Inc., Rtx-1 (length: 30 m, bore: 0.32 mm, film thickness: 0.25 μm) made by Restek Corporation and BP-1 (length: 30 m, bore: 0.32 mm, film thickness: 0.25 μm) made by SGE International Pty. Ltd. A capillary column CBP1-M50-025 (length: 50 m, bore: 0.25 mm, film thickness: 0.25 μm) made by Shimadzu Corporation may also be used for avoiding an overlap of peaks of the compounds.

The proportions of the liquid crystal compounds contained in the composition may be calculated by the method as described below. A mixture of the liquid crystal compounds was detected by gas chromatograph (FID). The ratio of the peak areas in the gas chromatogram corresponds to the ratio (weight ratio) of the liquid crystal compounds. When the capillary column described above was used, a correction coefficient of each of the liquid crystal compounds may be regarded as 1 (one). Accordingly, the proportions (wt %) of the liquid crystal compounds can be calculated from the ratio of the peak areas.

Sample for measurement: When the characteristics of a composition and the device were to be measured, the composition was used as was. When the characteristics of s compound were to be measured, a sample for measurement was prepared by mixing the compound (15 wt %) with a base liquid crystal (85 wt %). The values of the characteristics of a compound were calculated using the values obtained by the measurement, with an extrapolation method: (extrapolated value)={(measured value of a sample for measurement)−0.85×(measured value of a base liquid crystal)}/0.15. When a smectic phase (or crystals) precipitated at the ratio at 25° C., the ratio of the compound to the base liquid crystal was changed step by step in the order of (10 wt %: 90 wt %), (5 wt %: 95 wt %) and (1 wt %: 99 wt %). The values of maximum temperature, optical anisotropy, viscosity and dielectric anisotropy with regard to the compound were determined with the extrapolation method.

The base liquid crystal described below was used. The proportions of the component compounds were expressed in terms of weight percent (wt %).

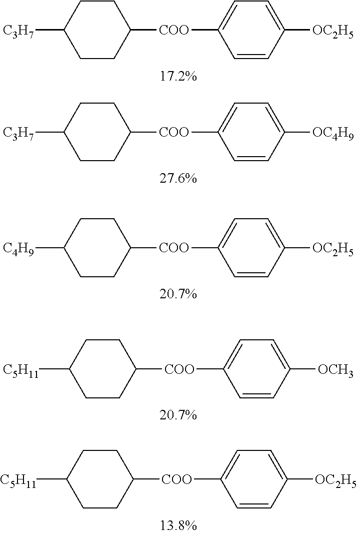

Measuring method: Characteristics were measured by methods described below. Most of the methods are applied as described in the standard “JEITA ED-2521B” discussed and established by Japan Electronics and Information Technology Industries Association (JEITA), or as modified thereon. No thin film transistor (TFT) was attached to the TN device used for the measurement.

1) Maximum temperature of nematic phase (NI; ° C.): A sample was placed on a hot plate in a melting point apparatus equipped with a polarizing microscope and was heated at a rate of 1° C./min. The temperature at which a part of the sample began to change from a nematic phase to an isotropic liquid was measured. The higher limit of the temperature range of the nematic phase may be occasionally abbreviated as “maximum temperature.”

2) Minimum temperature of nematic phase (Tₐ; ° C.): Samples each having a nematic phase were put in glass vials and kept in freezers at temperatures of 0° C., −10° C., −20° C., −30° C. and −40° C. for 10 days, and then liquid crystal phases were observed. For example, when the sample maintained the nematic phase at −20° C. and changed to crystals or a smectic phase at −30° C., To was expressed as T_{c}<−20° C. The lower limit of the temperature range of the nematic phase may be occasionally abbreviated as “minimum temperature.”

3) Viscosity (bulk viscosity; n; measured at 20° C.; mPa·s): A cone-plate (E type) rotational viscometer made by TOKYO KEIKI INC. was used for the measurement.

4) Viscosity (rotational viscosity; yl; measured at 25° C.; mPa·s): Measurement was carried out with the method described in M. Imai et al., Molecular Crystals and Liquid Crystals, Vol. 259, p. 37 (1995). A sample was put in a VA device in which the distance (cell gap) between two glass substrates was 20 μm. Voltage was applied stepwise to the device in the range of 39 V to 50 V at an increment of 1 V. After 0.2 sec with no voltage application, a voltage was applied repeatedly under conditions of only one rectangular wave (rectangular pulse; 0.2 sec) and no application (2 sec). The peak current and the peak time of a transient current generated by the applied voltage were measured. The value of the rotational viscosity was obtained from the measured values with Equation (8) on page 40 of the paper of M. Imai et al. The dielectric anisotropy required for the calculation was measured by the method described in section 6) later.

5) Optical anisotropy (refractive index anisotropy; Δn; measured at 25° C.): Measurement was carried out by an Abbe refractometer with a polarizing plate mounted on an ocular, using light at a wavelength of 589 nm. A surface of the main prism was rubbed in one direction, and then a sample was added dropwise onto the main prism. The refractive index n_{∥} was measured when the direction of polarized light was parallel to the direction of rubbing. The refractive index n_{⊥} was measured when the direction of polarized light was perpendicular to the direction of rubbing. The value of optical anisotropy was calculated from the equation “Δn=n_{∥}−n_{⊥}.”

6) Dielectric anisotropy (As; measured at 25° C.): The value of dielectric anisotropy was calculated from the equation “Δ∈=∈_{∥}−∈_{⊥}.” The dielectric constants ∈_{∥} and ∈_{⊥} were measured as described below.

i) Measurement of dielectric constant ∈_{∥}: An ethanol (20 mL) solution of octadecyl triethoxysilane (0.16 mL) was applied to a well-cleaned glass substrate. After rotating the glass substrate with a spinner, the glass substrate was heated at 150° C. for 1 hour. A sample was put in a VA device in which the distance (cell gap) between two glass substrates was 4 μm, and the device was sealed with a UV-curable adhesive. Sine waves (0.5 V, 1 kHz) were applied to the device, and after 2 sec, the dielectric constant ∈_{∥} in the major axis direction of liquid crystal molecules was measured.

ii) Measurement of dielectric constant ∈_{⊥}: A polyimide solution was applied to a well-cleaned glass substrate. After calcining the glass substrate, rubbing treatment was applied to the alignment film obtained. A sample was put in a TN device in which the distance (cell gap) between two glass substrates was 9 μm and the twist angle was 80°. Sine waves (0.5 V, 1 kHz) were applied to the device, and after 2 sec, the dielectric constant ∈_{⊥} in the minor axis direction of the liquid crystal molecules was measured.

7) Threshold voltage (Vth; measured at 25° C.; V): An LCD-5100 luminance meter made by Otsuka Electronics Co., Ltd. was used for the measurement. The light source was a halogen lamp. A sample was put in a normally black mode VA device in which the distance (cell gap) between two glass substrates was 4 μm and the rubbing direction was anti-parallel, and the device was sealed with an UV-curable adhesive. A voltage (60 Hz, rectangular waves) to be applied to the device was stepwise increased from 0 V to 20 V at an increment of 0.02 V. On the occasion, the device was irradiated with light from a direction perpendicular to the device, and the amount of light transmitted through the device was measured. A voltage-transmittance curve was prepared, in which a maximum amount of light corresponds to 100% transmittance and a minimum amount of light corresponds to 0% transmittance. The threshold voltage is expressed in terms of the voltage at 10% transmittance.

8) Voltage holding ratio (VHR-1; measured at 25° C.; %): A TN device used for the measurement had a polyimide alignment film, and the distance (cell gap) between two glass substrates was 5 m. A sample was put in the device, and then the device was sealed with a UV-curable adhesive. A pulse voltage (60 μs at 5 V) was applied to the TN device to charge the device. A decaying voltage was measured for 16.7 milliseconds with a high-speed voltmeter, and area A between a voltage curve and a horizontal axis in a unit cycle, and area B as an area without decay were determined. The voltage holding ratio is expressed in terms of the percentage of area A to area B.

9) Voltage holding ratio (VHR-2; measured at 800° C.; %): A voltage holding ratio was measured in procedures identical with the procedures described above except that the voltage holding ratio was measured at 80° C. instead of 25° C. The values obtained were expressed by VHR-2.

10) Voltage holding ratio (VHR-3; measured at 25° C.; %): The stability to UV light was evaluated by measuring the voltage holding ratio after a device was irradiated with UV light. The TN device used for the measurement had a polyimide alignment film, and a cell gap of 5 μm. A sample was injected into the device, and then the device was irradiated with light for 20 min. The light source was an ultra high-pressure mercury lamp USH-500D (made by Ushio, Inc.), and the distance between the device and the light source was 20 cm. In measuring VHR-3, a decaying voltage was measured for 16.7 milliseconds. A composition having a large VHR-3 has a large stability to UV light. The value of VHR-3 is preferably 90% or more, and further preferably 95% or more.

11) Voltage holding ratio (VHR-4; measured at 25° C.; %): A TN device into which a sample was injected was heated in a constant-temperature bath at 80° C. for 500 hours, and then stability to heat was evaluated by measuring a voltage holding ratio. In measuring VHR-4, a decaying voltage was measured for 16.7 milliseconds. A composition having a large VHR-4 has a large stability to heat.

12) Response time (T; measured at 25° C.; ms): An LCD-5100 luminance meter made by Otsuka Electronics Co., Ltd. was used for the measurement. The light source was a halogen lamp. A low-pass filter was set at 5 kHz. A sample was put in a normally black mode VA device in which the distance (cell gap) between two glass substrates was 4 μm and the rubbing direction was anti-parallel. Then, the device was sealed using an UV-curable adhesive. Rectangular waves (60 Hz, 10 V, 0.5 sec) were applied to the device. On the occasion, the device was irradiated with light from a direction perpendicular to the device, and the amount of light transmitted through the device was measured. The maximum amount of light corresponds to 100% transmittance, and the minimum amount of light corresponds to 0% transmittance. The response time was expressed in terms of the time required for a change from 90% transmittance to 10% transmittance (fall time; millisecond).

13) Specific resistance (ρ; measured at 25° C.; Ω·cm): Into a vessel equipped with electrodes, 1.0 mL of sample was injected. A DC voltage (10 V) was applied to the vessel, and a DC current after 10 sec was measured. The specific resistance ρ was calculated from the equation “ρ={(voltage)×(electric capacity of a vessel)}/{(direct current)×(dielectric constant of vacuum)}.”

The compounds in Examples were described using symbols according to definitions in Table 3 below. In Table 3, the configuration of 1,4-cyclohexylene is trans. A parenthesized number next to a symbolized compound corresponds to the number of the compound. The symbol “(−)” means any other liquid crystal compound. The proportion (percentage) of a liquid crystal compound is expressed in terms of weight percent (wt %) based on the weight of the liquid crystal composition. The values of the characteristics of the composition were summarized in the last part.

TABLE 3
Method for Description of Compounds using Symbols
R—(A₁)—Z₁— . . . —Zₙ—(Aₙ)—R′

| 1) Left-terminal Group R— | Symbol |
|---|---|
| FCₙH₂ₙ— | Fn- |
| CₙH₂ₙ₊₁— | n- |
| CₙH₂ₙ₊₁O— | nO— |
| CₘH₂ₘ₊₁OCₙH₂ₙ— | mOn- |
| CH₂═CH— | V— |
| CₙH₂ₙ₊₁—CH═CH— | nV— |
| CH₂═CH—CₙH₂ₙ— | Vn- |
| CₘH₂ₘ₊₁—CH═CH—CₙH₂ₙ— | mVn- |
| CF₂═CH— | VFF— |
| CF₂═CH—CₙH₂ₙ— | VFFn- |
| CH₂═CH—COO— | AC— |
| CH₂═C(CH₃)—COO— | MAC— |
| 2) Right-terminal Group —R′ | Symbol |
| —CₙH₂ₙ₊₁ | -n |
| —OCₙH₂ₙ₊₁ | —On |
| —CH═CH₂ | —V |
| —CH═CH—CₙH₂ₙ₊₁ | —Vn |
| —CₙH₂ₙ—CH═CH₂ | -nV |
| —CₘH₂ₘ—CH═CH—CₙH₂ₙ₊₁ | -mVn |
| —CH═CF₂ | —VFF |
| —OCO—CH═CH₂ | —AC |
| —OCO—C(CH₃)═CH₂ | —MAC |
| 3) Bonding Group —Zₙ— | Symbol |
| —CₙH₂ₙ— | n |
| —COO— | E |
| —CH═CH— | V |
| —CH═CHO— | VO |
| —OCH═CH— | OV |
| —CH₂O— | 1O |
| —OCH₂— | O1 |
| 4) Ring Structure —Aₙ— | Symbol |
| 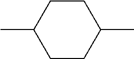 | H |
| 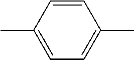 | B |
| 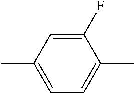 | B(F) |
| 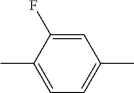 | B(2F) |
| 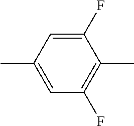 | B(F, F) |
| 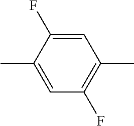 | B(2F, 5F) |
| 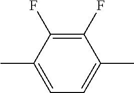 | B(2F, 3F) |
| 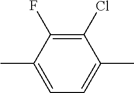 | B(2F, 3CL) |
| 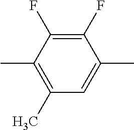 | B(2F, 3F, 6Me) |
| 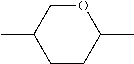 | dh |
| 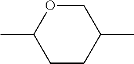 | Dh |
| 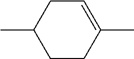 | ch |
| 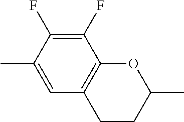 | Cro(7F, 8F) |

5) Examples of Description
Example 1. V2—HH2B(2F, 3F)—O2

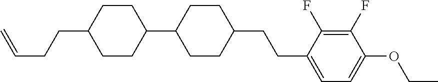 [SMILES: C=CCCC1CCC(C2CCC(CCc3ccc(OCC)c(F)c3F)CC2)CC1]

Example 2. 3-HBB(2F, 3F)—O2

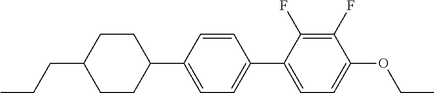 [SMILES: CCCC1CCC(c2ccc(-c3ccc(OCC)c(F)c3F)cc2)CC1]

Example 3. V—HHB-1

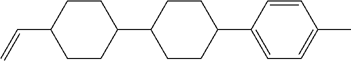 [SMILES: C=CC1CCC(C2CCC(c3ccc(C)cc3)CC2)CC1]

Example 4. 3-HDhB(2F, 3F)—O2

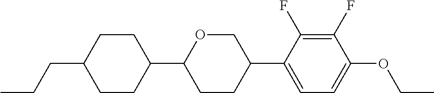 [SMILES: CCCC1CCC(C2CCC(c3ccc(OCC)c(F)c3F)CO2)CC1]

### Comparative Examples 1

Example 2 was selected from compositions disclosed in WO 2010-067662 A. A reason is that the composition contains compounds (1), (3) and (4), and also the maximum temperature is highest and the optical anisotropy is largest. The components and characteristics of the composition are as described below.

| | | |
|---|---|---|
| V-H2B (2F, 3F)-O2 | (1-1) | 10% |
| 3-HH-V | (3-1) | 30% |
| 3-HH-V1 | (3-1) | 4% |
| V-HHB-1 | (3-4) | 6% |
| V2-HHB-1 | (3-4) | 3% |
| V-HB (2F, 3F)-O2 | (4-1) | 14% |
| V-HHB (2F, 3F)-O2 | (4-3) | 5% |
| V2-HHB (2F, 3F)-O2 | (4-3) | 5% |
| 2-HHB (2F, 3Cl)-O2 | (4-8) | 2% |
| 3-HHB (2F, 3Cl)-O2 | (4-8) | 3% |
| V-HBB (2F, 3F)-O2 | (-) | 10% |
| V2-HBB (2F, 3F)-O2 | (-) | 8% |

NI=74.8° C.; Tc≦−20° C.; Δn=0.091; Δ∈=−2.9; Vth=2.12 V; η=14.1 mPa·s; τ=5.7 ms; VHR-1=99.0%; VHR-2=98.0%; VHR-3=98.0%.

### Example 1

| | | |
|---|---|---|
| V-HH2B (2F, 3F)-O2 | (1-2) | 10% |
| 5-B (F) BB-2 | (2-4) | 6% |
| 3-HBB-2 | (2-7) | 3% |
| 3-HH-V | (3-1) | 24% |
| 5-HH-V | (3-1) | 3% |
| 3-HH-V1 | (3-1) | 8% |
| 3-HH-VFF | (3-1) | 4% |
| V2-HHB-1 | (3-4) | 10% |
| 3-H1OB (2F, 3F)-O2 | (4-2) | 9% |
| V-HHB (2F, 3F)-O1 | (4-3) | 8% |
| V-HHB (2F, 3F)-O2 | (4-3) | 7% |
| 3-HH1OB (2F, 3F)-O2 | (4-4) | 5% |
| 3-H1OCro (7F, 8F)-5 | (4-9) | 3% |

NI=89.9° C.; Tc<−20° C.; Δn=0.095; Δ∈=−2.8; Vth=2.55 V; η=18.2 mPa·s.

### Example 2

| | | |
|---|---|---|
| V-HH2B (2F, 3F)-O2 | (1-2) | 11% |
| 1-BB-5 | (2-1) | 7% |
| 3-BB (2F, 3F)-O4 | (2-2) | 3% |
| 2O-B (2F, 3F) B (2F, 3F)-O6 | (2-3) | 3% |
| 2-BB (2F, 3F) B-3 | (2-6) | 6% |
| 3-HH-V | (3-1) | 28% |
| 3-HH-V1 | (3-1) | 9% |
| V-HHB (2F, 3F)-O1 | (4-3) | 5% |
| V-HHB (2F, 3F)-O2 | (4-3) | 11% |
| 3-HH1OB (2F, 3F)-O2 | (4-4) | 10% |
| V2-BB (2F, 3F)-O2 | (-) | 7% |

NI=76.9° C.; Tc<−20° C.; Δn=0.107; Δ∈=−3.1; Vth=2.38 V; η=16.7 mPa·s; VHR-1=99.1%; VHR-2=98.2%.

### Example 3

| | | |
|---|---|---|
| V-H2B (2F, 3F)-O2 | (1-1) | 5% |
| V2-H2B (2F, 3F)-O2 | (1-1) | 4% |
| 1-BB-3 | (2-1) | 3% |
| 2O-BB (2F, 3F)-O2 | (2-2) | 3% |
| 3-dhBB (2F, 3F)-O2 | (2-9) | 4% |
| 2-HH-3 | (3-1) | 23% |
| 3-HH-O1 | (3-1) | 6% |
| 4-HH-V1 | (3-1) | 8% |
| 3-HB (2F, 3F)-O4 | (4-1) | 3% |
| 2-HH1OB (2F, 3F)-O2 | (4-4) | 7% |
| 3-HH1OB (2F, 3F)-O2 | (4-4) | 20% |
| V-HBB-2 | (-) | 10% |
| 1-BB (F) B-2V | (-) | 4% |

NI=77.1° C.; Tc<−20° C.; Δn=0.096; Δ∈=−3.1; Vth=2.26 V; η=16.4 mPa·s; VHR-1=99.2%; VHR-2=98.1%.

### Example 4

| | | |
|---|---|---|
| V2-HH2B (2F, 3F)-O2 | (1-2) | 5% |
| 1V-HH2B (2F, 3F)-O2 | (1-2) | 3% |
| 3-BB (2F, 3F)-O2 | (2-2) | 10% |
| 5-BB (2F, 3F)-O2 | (2-2) | 4% |
| 3-HBB-2 | (2-7) | 8% |
| 2-HH-3 | (3-1) | 14% |
| 3-HH-V1 | (3-1) | 9% |
| 3-HB-O2 | (3-2) | 8% |
| V-HHB-1 | (3-4) | 3% |
| 3-HHEBH-3 | (3-5) | 3% |
| V-HHB (2F, 3F)-O1 | (4-3) | 6% |
| V-HHB (2F, 3F)-O2 | (4-3) | 8% |
| V2-HHB (2F, 3F)-O2 | (4-3) | 7% |
| 3-HDhB (2F, 3F)-O2 | (4-6) | 5% |
| V2-BB (2F, 3F)-O2 | (-) | 7% |

NI=86.7° C.; Tc<−20° C.; Δn=0.109; Δ∈=−3.2; Vth=2.35 V; η=12.9 mPa·s.

### Example 5

| | | |
|---|---|---|
| 1V-H2B (2F, 3F)-O4 | (1-1) | 3% |
| V-HH2B (2F, 3F)-O4 | (1-2) | 4% |
| 1V-HH2B (2F, 3F)-O4 | (1-2) | 5% |
| 2-BB (F) B-3 | (2-5) | 3% |
| 3-HBB (2F, 3F)-O2 | (2-8) | 4% |
| 2-HH-3 | (3-1) | 6% |
| 3-HH-V | (3-1) | 23% |
| 3-HHB-O1 | (3-4) | 3% |
| V-HHB-1 | (3-4) | 4% |
| 5-HBB (F) B-3 | (3-9) | 3% |
| 2-HHB (2F, 3CL)-O2 | (4-8) | 3% |
| 3-HHB (2F, 3CL)-O2 | (4-8) | 3% |
| 3-H2B (2F, 3F)-O2 | (-) | 13% |
| 5-H2B (2F, 3F)-O2 | (-) | 14% |
| 3-HBB (2F, 3CL)-O2 | (-) | 3% |
| 5-HBB (2F, 3CL)-O2 | (-) | 6% |

NI=77.3° C.; Tc<−20° C.; Δn=0.095; Δ∈=−2.8; Vth=2.34 V; η=16.3 mPa·s.

### Example 6

| | | |
|---|---|---|
| V2-H2B (2F, 3F)-O4 | (1-1) | 3% |
| V-HH2B (2F, 3F)-O2 | (1-2) | 8% |
| V2-HH2B (2F, 3F)-O4 | (1-2) | 8% |
| 1-BB-3 | (2-1) | 6% |
| 5-BB (2F, 3F)-O4 | (2-2) | 4% |
| 2-HBB (2F, 3F)-O2 | (2-8) | 4% |
| 3-HBB (2F, 3F)-O2 | (2-8) | 5% |
| 5-HBB (2F, 3F)-O2 | (2-8) | 7% |
| 2-HH-3 | (3-1) | 21% |
| 2-HH-5 | (3-1) | 3% |
| 3-HB-O2 | (3-2) | 4% |
| 2-H1OB (2F, 3F)-O2 | (4-2) | 3% |
| 3-H1OB (2F, 3F)-O2 | (4-2) | 8% |
| 3-HHB (2F, 3F)-O2 | (4-3) | 8% |
| V-HHB (2F, 3F)-O2 | (4-3) | 8% |

NI=77.0° C.; Tc<−20° C.; Δn=0.099; Δ∈=−3.4; Vth=2.09 V; η=18.9 mPa·s.

### Example 7

| | | |
|---|---|---|
| V-H2B (2F, 3F)-O4 | (1-1) | 4% |
| 1V-H2B (2F, 3F)-O2 | (1-1) | 4% |
| 1-BB-5 | (2-1) | 5% |
| 3-HBB (2F, 3F)-O2 | (2-8) | 10% |
| 5-HBB (2F, 3F)-O2 | (2-8) | 7% |
| 2-HH-3 | (3-1) | 22% |
| 3-HH-4 | (3-1) | 4% |
| 4-HH-V1 | (3-1) | 3% |
| 3-HB-O2 | (3-2) | 3% |
| 5-HB-O2 | (3-2) | 5% |
| 3-HHB-1 | (3-4) | 7% |
| 5-HBB (F) B-2 | (3-9) | 3% |
| V-HB (2F, 3F)-O2 | (4-1) | 8% |
| V-HHB (2F, 3F)-O4 | (4-3) | 7% |
| V-HBB-3 | (-) | 5% |
| 1V2-HBB (2F, 3F)-O2 | (-) | 3% |

NI=78.3° C.; Tc<−20° C.; Δn=0.104; Δ∈=−2.1; Vth=2.57 V; η=13.9 mPa·s.

### Example 8

| | | |
|---|---|---|
| V-H2B (2F, 3F)-O2 | (1-1) | 6% |
| V2-H2B (2F, 3F)-O2 | (1-1) | 5% |
| V-HH2B (2F, 3F)-O2 | (1-2) | 5% |
| 1-BB-3 | (2-1) | 7% |
| 3-BB (2F, 3F)-O2 | (2-2) | 4% |
| 2O-BB (2F, 3F)-O2 | (2-2) | 3% |
| 3-HEB (2F, 3F) B (2F, 3F)-O2 | (2-10) | 3% |
| 3-HH-V | (3-1) | 31% |
| 3-HH-V1 | (3-1) | 3% |
| V2-HHB-1 | (3-4) | 5% |
| 5-HBBH-3 | (3-7) | 5% |
| 3-H1OB (2F, 3F)-O2 | (4-2) | 3% |
| 3-HH1OB (2F, 3F)-O2 | (4-4) | 14% |
| 3-HDhB (2F, 3F)-O2 | (4-6) | 3% |
| 3-HH1OCro (7F, 8F)-5 | (4-10) | 3% |

NI=77.6° C.; Tc<−20° C.; Δn=0.097; Δ∈=−3.6; Vth=2.17 V; η=18.8 mPa·s.

### Example 9

| | | |
|---|---|---|
| V-HH2B (2F, 3F)-O2 | (1-2) | 8% |
| 1-BB-5 | (2-1) | 12% |
| 3-BB (2F, 3F)-O2 | (2-2) | 5% |
| 3-HBB (2F, 3F)-O2 | (2-8) | 9% |
| 5-HBB (2F, 3F)-O2 | (2-8) | 8% |
| 2-HH-3 | (3-1) | 22% |
| 3-HH-4 | (3-1) | 3% |
| F3-HH-V | (3-1) | 3% |
| 7-HB-1 | (3-2) | 3% |
| 3-HHB-3 | (3-4) | 4% |
| 5-HB (F) BH-3 | (3-8) | 3% |
| 3-HB (2F, 3F)-O2 | (4-1) | 4% |
| 5-HB (2F, 3F)-O4 | (4-1) | 3% |
| 3-HHB (2F, 3F)-O2 | (4-3) | 9% |
| 3-DhHB (2F, 3F)-O2 | (4-5) | 4% |

NI=78.0° C.; Tc<−20° C.; Δn=0.105; Δ∈=−2.4; Vth=2.48 V; η=15.5 mPa·s.

### Example 10

| | | |
|---|---|---|
| V-H2B (2F, 3F)-O2 | (1-1) | 3% |
| V-HH2B (2F, 3F)-O2 | (1-2) | 11% |
| 3-BB (2F, 3F)-O2 | (2-2) | 10% |
| 5-BB (2F, 3F)-O2 | (2-2) | 9% |
| 3-HBB-2 | (2-7) | 4% |
| 2-HH-3 | (3-1) | 15% |
| 3-HH-V1 | (3-1) | 7% |
| 3-HHEH-3 | (3-3) | 3% |
| 3-HHEBH-5 | (3-5) | 3% |
| 3-HB (F) HH-2 | (3-6) | 3% |
| 3-HB (F) HH-5 | (3-6) | 3% |
| 3-HB (2F, 3F)-O2 | (4-1) | 12% |
| V-HHB (2F, 3F)-O2 | (4-3) | 9% |
| V2-HHB (2F, 3F)-O2 | (4-3) | 5% |
| 3-DhH1OB (2F, 3F)-O2 | (4-7) | 3% |

NI=81.0° C.; Tc<−20° C.; Δn=0.099; Δ∈=−3.3; Vth=2.42 V; η=17.0 mPa·s.

The compositions of Examples 1 to 10 had a higher maximum temperature and a larger optical anisotropy in comparison with the composition of Comparative Example 1. Accordingly, the liquid crystal composition of the invention is concluded to have better characteristics.

### INDUSTRIAL APPLICABILITY

The liquid crystal composition of the invention satisfies at least one of characteristics such as a high maximum temperature, a low minimum temperature, a small viscosity, a suitable optical anisotropy, a large negative dielectric anisotropy, a large specific resistance, a high stability to UV light and a high stability to heat, or has a suitable balance regarding at least two of the characteristics. The LCD device of the invention including such a composition has characteristics such as a short response time, a large voltage holding ratio, a low threshold voltage, a large contrast ratio and a long service life, and thus can be used for a liquid crystal projector, a liquid crystal television and so on.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

1. A liquid crystal composition that has a negative dielectric anisotropy and contains at least one compound selected from the group consisting of compounds represented by formula (1) as a first component and at least one compound selected from the group consisting of compounds represented by formula (2) as a second component: 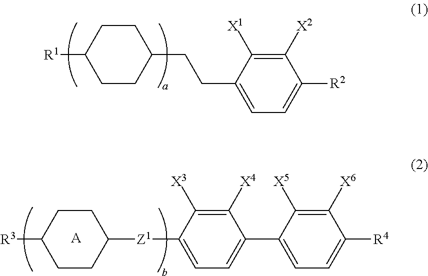
wherein in formula (1) and formula (2), R¹ is alkenyl having 2 to 4 carbons; R² is alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen; R³ and R⁴ are independently alkyl having 1 to 12 carbons, alkoxy having 1 to 12 carbons, or alkyl having 1 to 12 carbons in which at least one hydrogen is replaced by halogen; ring A is 1,4-cyclohexylene, 1,4-cyclohexenylene, 1,4-phenylene, 1,4-phenylene in which at least one hydrogen is replaced by fluorine or chlorine, or tetrahydropyran-2,5-diyl; X¹ and X² are independently fluorine or chlorine; X³, X⁴, X⁵ and X⁶ are independently hydrogen, fluorine or chlorine; Z¹ is a single bond, —CH₂CH₂—, —CH₂O—, —OCH₂—, —COO— or —OCO—; a is 1 or 2; and b is 0 or 1.

2. The liquid crystal composition of claim 1, wherein the first component contains at least one compound selected from the group consisting of compounds represented by formula (1-1) and formula (1-2) 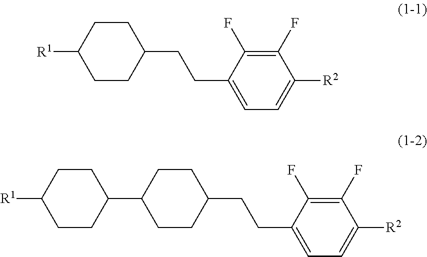
wherein in formula (1-1) and formula (1-2), R¹ is alkenyl having 2 to 4 carbons; R² is alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen.

3. The liquid crystal composition of claim 1, wherein the second component contains at least one compound selected from the group consisting of compounds represented by formula (2-1) to formula (2-10): 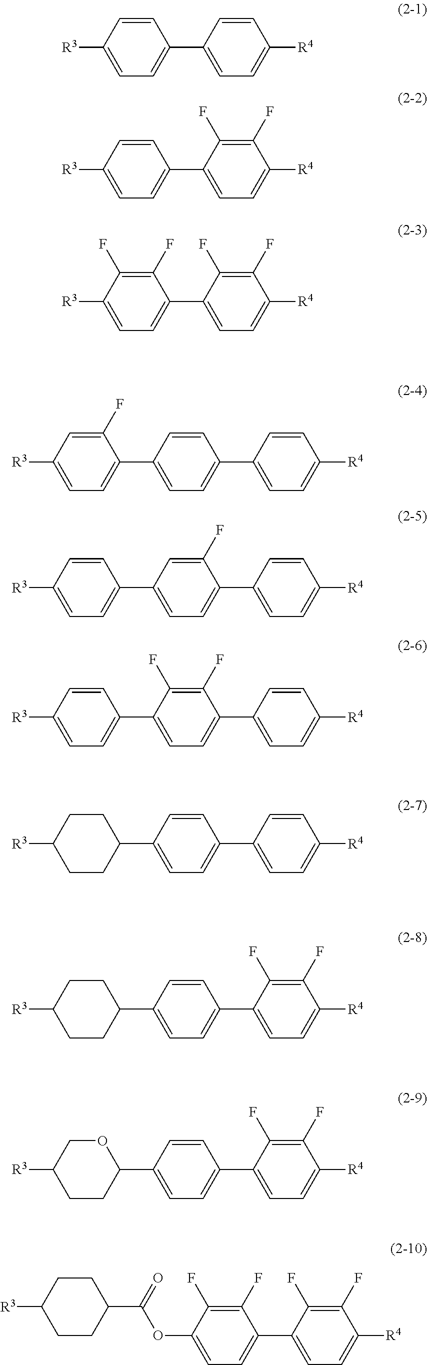
wherein in formula (2-1) to formula (2-10), R³ and R⁴ are independently alkyl having 1 to 12 carbons, alkoxy having 1 to 12 carbons, or alkyl having 1 to 12 carbons in which at least one hydrogen is replaced by halogen.

4. The liquid crystal composition of claim 1, wherein a proportion of the first component is in a range of 5 wt % to 50 wt % and a proportion of the second component is in a range of 5 wt % to 50 wt %, based on a weight of the liquid crystal composition.

5. The liquid crystal composition of claim 1, further containing at least one compound selected from the group consisting of compounds represented by formula (3) as a third component: 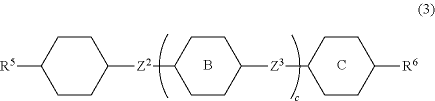
wherein in formula (3), R⁵ and R⁶ are independently alkyl having 1 to 12 carbons, alkoxy having 1 to 12 carbons, alkenyl having 2 to 12 carbons, alkyl having 1 to 12 carbons in which at least one hydrogen is replaced by halogen, or alkenyl having 2 to 12 carbons in which at least one hydrogen is replaced by halogen; ring B and ring C are independently 1,4-cyclohexylene, 1,4-phenylene, 2-fluoro-1,4-phenylene or 2,5-difluoro-1,4-phenylene; Z² and Z³ are independently a single bond, —CH₂CH₂—, —CH₂O—, —OCH₂—, —COO— or —OCO—; and c is 0, 1 or 2; and when c is 1, ring B is 1,4-cyclohexylene.

6. The liquid crystal composition of claim 5, wherein the third component contains at least one compound selected from the group consisting of compounds represented by formula (3-1) to formula (3-9): 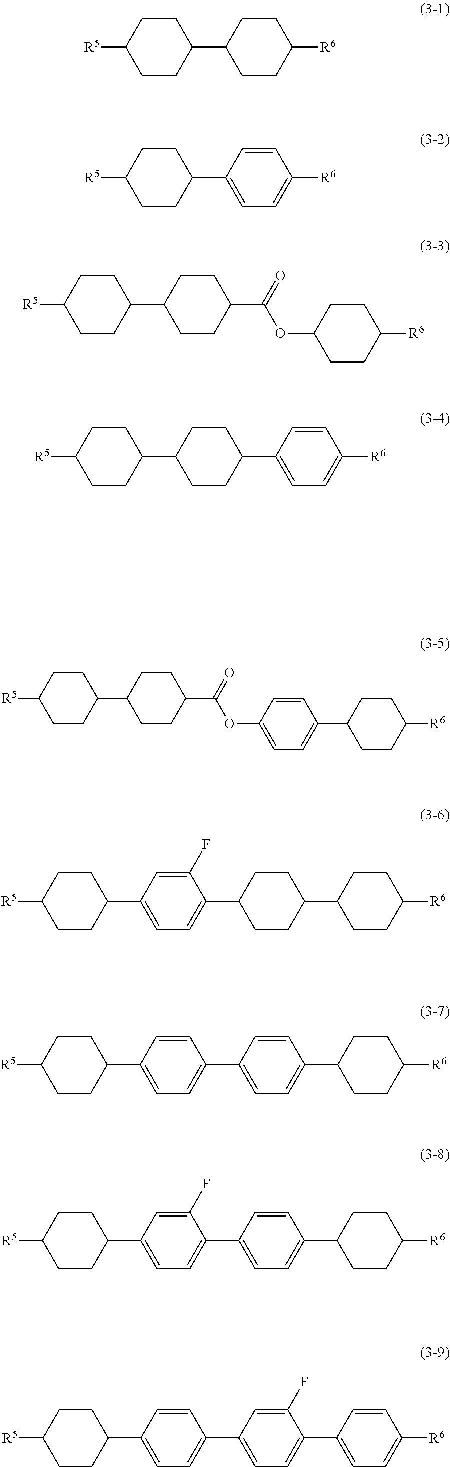
wherein in formula (3-1) to formula (3-9), R5 and R⁶ are independently alkyl having 1 to 12 carbons, alkoxy having 1 to 12 carbons, alkenyl having 2 to 12 carbons, alkyl having 1 to 12 carbons in which at least one hydrogen is replaced by halogen, or alkenyl having 2 to 12 carbons in which at least one hydrogen is replaced by halogen.

7. The liquid crystal composition of claim 5, wherein a proportion of the third component is in a range of 10 wt % to 90 wt % based on a weight of the liquid crystal composition.

8. The liquid crystal composition of claim 1, further containing at least one compound selected from the group consisting of compounds represented by formula (4) as a fourth component: 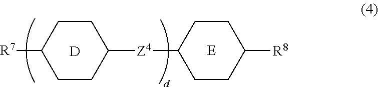
wherein in formula (4), R⁷ and R⁸ are independently alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen; ring D is 1,4-cyclohexylene, 1,4-cyclohexenylene or tetrahydropyran-2,5-diyl; ring E is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl; Z⁴ is a single bond, —CH₂O—, —OCH₂—, —COO— or —OCO—; and d is 1, 2 or 3.

9. The liquid crystal composition of claim 8, wherein the fourth component contains at least one compound selected from the group consisting of compounds represented by formula (4-1) to formula (4-10): 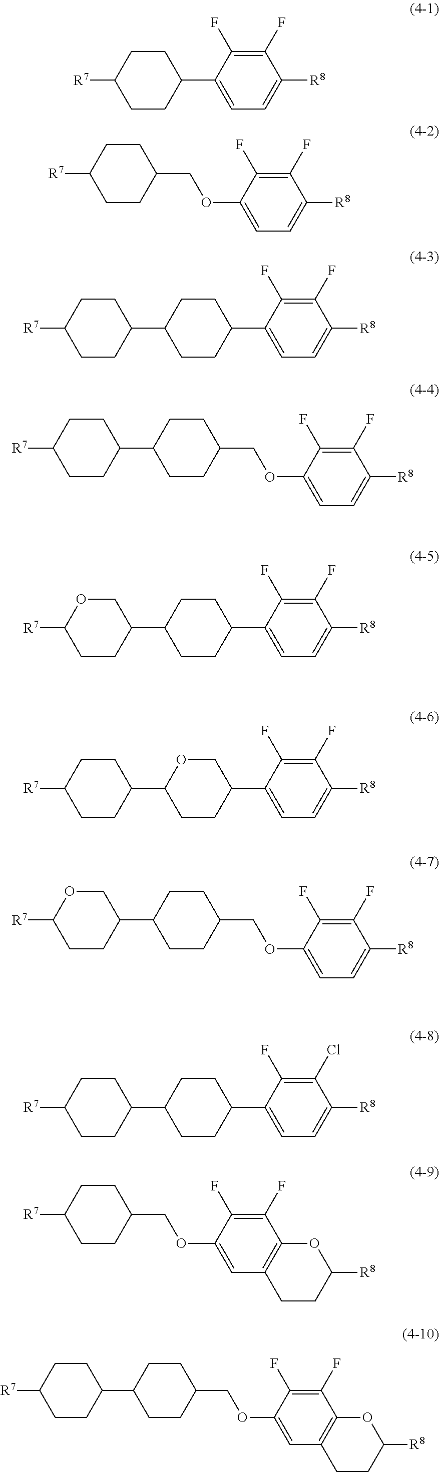
wherein in formula (4-1) to formula (4-10), R⁷ and R⁸ are independently alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen.

10. The liquid crystal composition of claim 8, wherein a proportion of the fourth component is in a range of 5 wt % to 70 wt % based on a weight of the liquid crystal composition.

11. The liquid crystal composition of claim 5, further containing at least one compound selected from the group consisting of compounds represented by formula (4) as a fourth component: 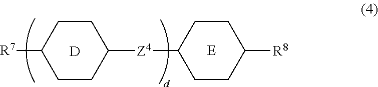
wherein in formula (4), R⁷ and R⁸ are independently alkyl having 1 to 12 carbons, alkoxy having 1 to 12 carbons, alkenyl having 2 to 12 carbons, alkenyloxy having 2 to 12 carbons, alkyl having 1 to 12 carbons in which at least one hydrogen is replaced by halogen, or alkenyl having 2 to 12 carbons in which at least one hydrogen is replaced by halogen; ring D is 1,4-cyclohexylene, 1,4-cyclohexenylene or tetrahydropyran-2,5-diyl; ring E is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl; Z⁴ is a single bond, —CH₂O—, —OCH₂—, —COO— or —OCO—; and d is 1, 2 or 3.

12. The liquid crystal composition of claim 1, further containing at least one polymerizable compound selected from the group consisting of compounds represented by formula (5) as an additive component: 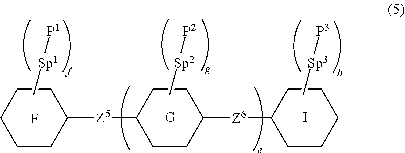
wherein in formula (5), ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen; ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen; Z⁵ and Z⁶ are independently a single bond or alkylene having 1 to 10 carbons, and in the alkylene, at least one —CH₂— may be replaced by —O—, —CO—, —COO— or —OCO—, at least one —CH₂—CH₂— may be replaced by —CH═CH—, —C(CH₃)═CH—, —CH═C(CH₃)— or —C(CH₃)═C(CH₃)—, and in the groups, at least one hydrogen may be replaced by fluorine or chlorine; P¹, P² and P³ are independently a polymerizable group; Sp¹, Sp² and Sp³ are independently a single bond or alkylene having 1 to 10 carbons, and in the alkylene, at least one —CH₂— may be replaced by —O—, —COO—, —OCO— or —OCOO—, at least one —CH₂—CH₂— may be replaced by —CH═CH— or —C≡C—, and in the groups, at least one hydrogen may be replaced by fluorine or chlorine; e is 0, 1 or 2; f, g and h are independently 0, 1, 2, 3 or 4; and the sum of f, g and h is 1 or more.

13. The liquid crystal composition of claim 12, wherein P¹, P² and P³ in formula (5) are independently a polymerizable group selected from the group consisting of groups represented by formula (P-1) to formula (P-6): 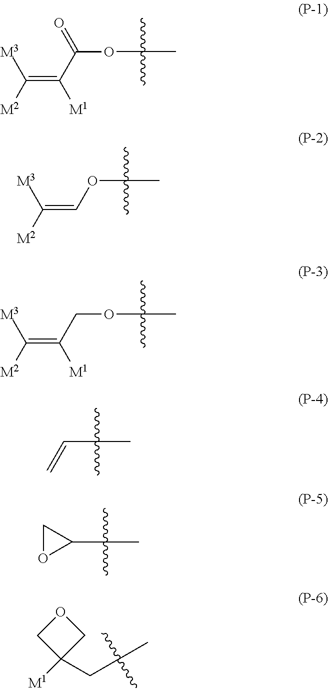
wherein in formula (P-1) to formula (P-6), M¹, M² and M³ are independently hydrogen, fluorine, alkyl having 1 to 5 carbons, or alkyl having 1 to 5 carbons in which at least one hydrogen is replaced by halogen; when all of the f piece(s) of P¹ and the h piece(s) of P³ are a group represented by formula (P-4), in formula (5), at least one of the f piece(s) of Sp¹ and the h piece(s) of Sp³ is alkylene in which at least one —CH₂— is replaced by —O—, —COO—, —OCO— or —OCOO—.

14. The liquid crystal composition of claim 12, wherein the additive component contains at least one polymerizable compound selected from the group consisting of compounds represented by formula (5-1) to formula (5-27): 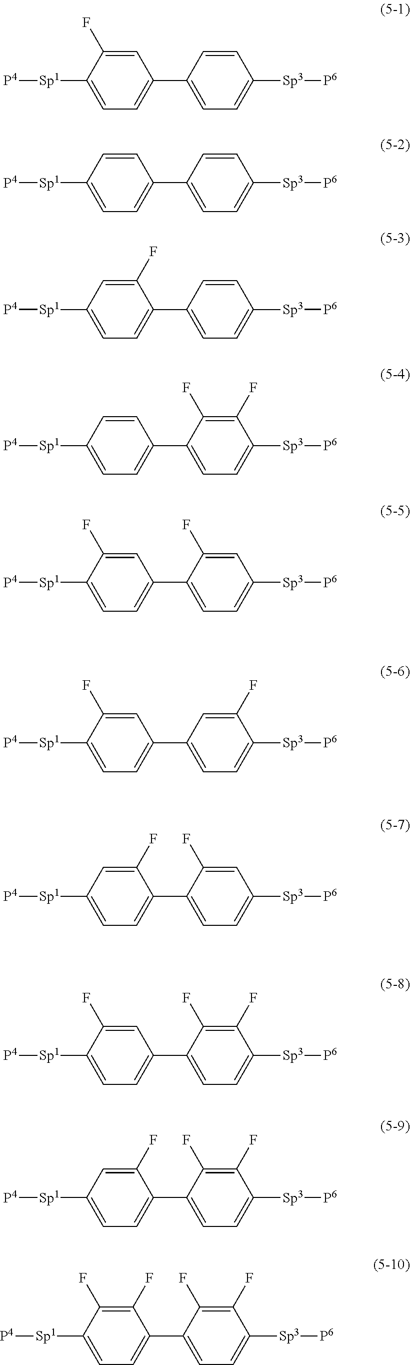 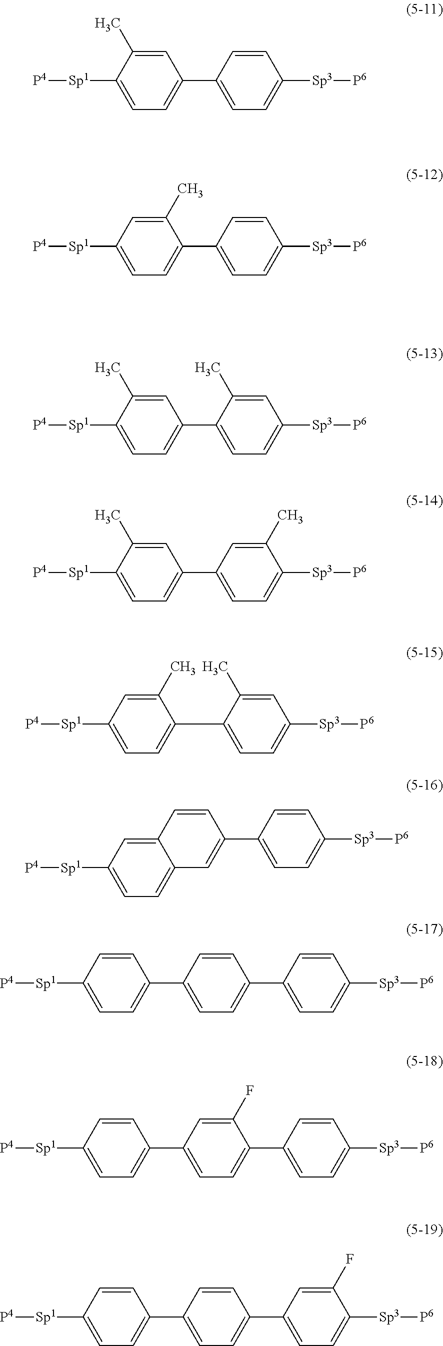 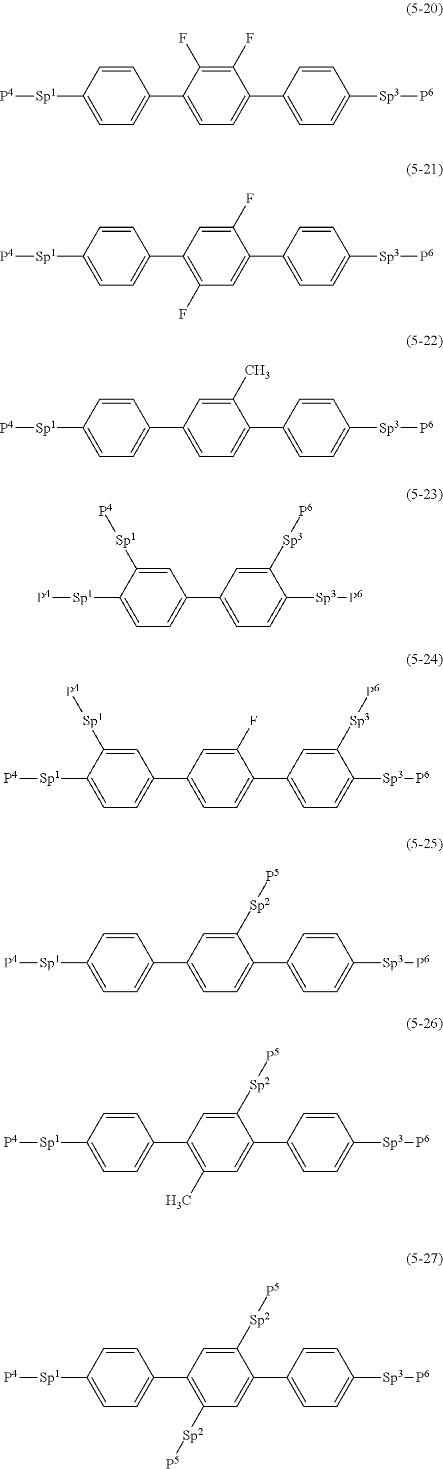
in formula (5-1) to formula (5-27), P⁴, P⁵ and P⁶ are independently a polymerizable group selected from the group consisting of groups represented by formula (P-1) to formula (P-3); 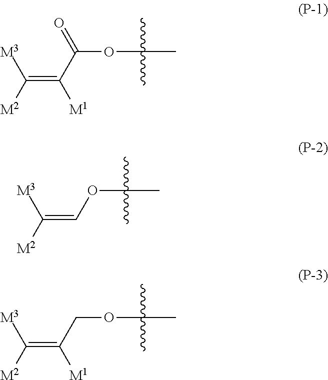
in formula (P-1) to formula (P-3), M¹, M² and M³ are independently hydrogen, fluorine, alkyl having 1 to 5 carbons, or alkyl having 1 to 5 carbons in which at least one hydrogen is replaced by halogen; and
in formula (5-1) to formula (5-27), Sp¹, Sp² and Sp³ are independently a single bond or alkylene having 1 to 10 carbons, and in the alkylene, at least one —CH₂— may be replaced by —O—, —COO—, —OCO— or —OCOO—, at least one —CH₂—CH₂— may be replaced by —CH═CH— or —C≡C—, and in the groups, at least one hydrogen may be replaced by fluorine or chlorine.

15. The liquid crystal composition of claim 12, wherein a proportion of addition of the additive component is in a range of 0.03 wt % to 10 wt % based on a weight of the liquid crystal composition.

16. The liquid crystal composition of claim 5, further containing at least one polymerizable compound selected from the group consisting of compounds represented by formula (5) as an additive component: 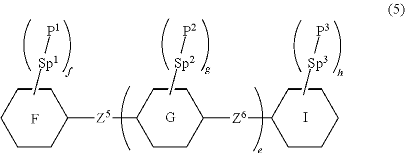
wherein in formula (5), ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen; ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen; Z⁵ and Z⁶ are independently a single bond or alkylene having 1 to 10 carbons, and in the alkylene, at least one —CH₂— may be replaced by —O—, —CO—, —COO— or —OCO—, at least one —CH₂—CH₂— may be replaced by —CH═CH—, —C(CH₃)═CH—, —CH═C(CH₃)— or —C(CH₃)═C(CH₃)—, and in the groups, at least one hydrogen may be replaced by fluorine or chlorine; P¹, P² and P³ are independently a polymerizable group; Sp¹, Sp² and Sp³ are independently a single bond or alkylene having 1 to 10 carbons, and in the alkylene, at least one —CH₂— may be replaced by —O—, —COO—, —OCO— or —OCOO—, at least one —CH₂—CH₂— may be replaced by —CH═CH— or —C≡C—, and in the groups, at least one hydrogen may be replaced by fluorine or chlorine; e is 0, 1 or 2; f, g and h are independently 0, 1, 2, 3 or 4; and the sum of f, g and h is 1 or more.

17. The liquid crystal composition of claim 11, further containing at least one polymerizable compound selected from the group consisting of compounds represented by formula (5) as an additive component: 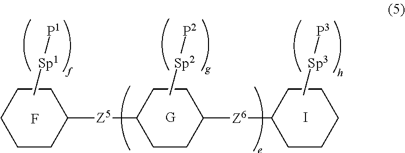
wherein in formula (5), ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen; ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen; Z⁵ and Z⁶ are independently a single bond or alkylene having 1 to 10 carbons, and in the alkylene, at least one —CH₂— may be replaced by —O—, —CO—, —COO— or —OCO—, at least one —CH₂—CH₂— may be replaced by —CH═CH—, —C(CH₃)═CH—, —CH═C(CH₃)— or —C(CH₃)═C(CH₃)—, and in the groups, at least one hydrogen may be replaced by fluorine or chlorine; P¹, P² and P³ are independently a polymerizable group; Sp¹, Sp² and Sp³ are independently a single bond or alkylene having 1 to 10 carbons, and in the alkylene, at least one —CH₂— may be replaced by —O—, —COO—, —OCO— or —OCOO—, at least one —CH₂—CH₂— may be replaced by —CH═CH— or —C≡C—, and in the groups, at least one hydrogen may be replaced by fluorine or chlorine; e is 0, 1 or 2; f, g and h are independently 0, 1, 2, 3 or 4; and the sum of f, g and h is 1 or more.

18. A liquid crystal display device, including the liquid crystal composition of claim 1.

19. The liquid crystal display device of claim 18, of which an operating mode is an IPS mode, a VA mode, an FFS mode or an FPA mode, and a driving mode is an active matrix mode.

20. A polymer sustained alignment (PSA) mode liquid crystal display device, including the liquid crystal composition of claim 12, or a composition obtained by polymerizing the polymerizable compound in the liquid crystal composition.
